(19) United States
(12) Patent Application Publication
(10) Pub. No.: US 2023/0228588 A1
(43) Pub. Date: Jul. 20, 2023

(54) ROUTE PROVISION APPARATUS AND ROUTE PROVISION METHOD THEREFOR

(71) Applicant: LG ELECTRONICS INC., Seoul (KR)

(72) Inventors: Jinsang LEE, Seoul (KR); Sujin KIM, Seoul (KR); Sungmin KIM, Seoul (KR); Jihyun KIM, Seoul (KR); Seunghwan BANG, Seoul (KR)

(73) Assignee: LG ELECTRONICS INC., Seoul (KR)

(21) Appl. No.: 18/008,086

(22) PCT Filed: Jun. 4, 2020
(86) PCT No.: PCT/KR2020/007267

§ 371 Date: Dec. 2, 2022

(51) Int. Cl. G01C 21/36; G01C 21/00; B60K 35/00

(52) U.S. Cl. CPC G01C 21/367; G01C 21/3658; G01C 21/3881; G01C 21/3878; G01C 21/3896; B60K 35/00; B60K 2370/1533; B60K 2370/166; B60K 2370/175; B60K 2370/67

(57) ABSTRACT

A processor of a route provision apparatus according to an embodiment of the present invention is characterized in outputting map information received from a server, on a rollable display provided in a vehicle, determining a change in the size of a display area of the rollable display, and requesting the server for map information to be displayed on the changed display area, on the basis of the changed size of the display area, and receiving the map information.

### TECHNICAL FIELD

The present disclosure relates to a route provision apparatus that provides a route to a vehicle and a route provision method therefor.

### BACKGROUND ART

A vehicle denotes a means of transporting people or goods using kinetic energy. Representative examples of vehicles include automobiles and motorcycles.

For safety and convenience of a user who uses the vehicle, various sensors and devices are provided in the vehicle, and the functions of the vehicle are diversified.

The function of the vehicle may be divided into a convenience function for promoting the convenience of a driver and a safety function for promoting the safety of a driver and/or a pedestrian.

First, the convenience function has a motive for development related to driver convenience, such as giving an infotainment (information+entertainment) function to the vehicle, supporting a partial autonomous driving function, or assisting the driver's vision such as night vision or blind spot. For example, the convenience function may include an active cruise control (ACC) function, a smart parking assist system (SPAS) function, a night vision (NV) function, a head up display (HUD) function, an around view monitor (AVM) function, and an adaptive headlight system (AHS) function, and the like.

The safety function is a technology for securing the safety of the driver and/or the safety of a pedestrian, and may include a lane departure warning system (LDWS) function, a lane keeping assist system (LKAS) function, an autonomous emergency braking (AEB) function, and the like.

For convenience of a user using a vehicle, various types of sensors and electronic devices are provided in the vehicle. In particular, for the convenience of the user's driving, research on an advanced driver assistance system (ADAS) is being actively carried out. Furthermore, development of an autonomous vehicle is being actively carried out.

In recent years, as the development of an advanced driving assist system (ADAS) is actively undergoing, development of a technology for optimizing user's convenience and safety while driving a vehicle is required.

As part of this effort, in order to effectively transmit eHorizon (electronic Horizon) data to autonomous driving systems and infotainment systems, the EU OEM (European Union Original Equipment Manufacturing) Association has established a data specification and transmission method as a standard under the name “ADASIS (ADAS (Advanced Driver Assist System) Interface Specification).”

In addition, eHorizon (software) has become an essential element of the safety/ECO/convenience of autonomous vehicles under a connected environment.

### DISCLOSURE OF INVENTION

### Technical Problem

The present disclosure is contrived to solve the foregoing problems and other problems.

An aspect of the present disclosure is to provide a route provision apparatus capable of providing field-of-view information for autonomous driving that enables autonomous driving, and a route provision method therefor.

Another aspect of the present disclosure is to provide a route provision apparatus compatible with a rollable display provided in a vehicle and a route provision method therefor.

Still another aspect of the present disclosure is to provide a route provision apparatus capable of providing optimized field-of-view information for autonomous driving and an optimal route through a rollable display provided in a vehicle, and a route provision method therefor.

### Solution to Problem

The present disclosure provides a route provision apparatus that provides a route to a vehicle and a route provision method therefor.

A route provision apparatus that provides a route to a vehicle according to an embodiment of the present disclosure may include a telecommunication control unit that receives map information configured with a plurality of layers from a server, an interface unit that receives sensing information from one or more sensors provided in the vehicle, and a processor that specifies any one lane in which the vehicle is located on a road consisting of a plurality of lanes based on an image received from the image sensor among the sensing information, estimates an optimal route expected or planned to move the vehicle based on the specified lane in units of lanes using the map information, generates field-of-view information for autonomous driving merged with the sensing information on the optimal route to transmit it to at least one of the server and an electrical part provided in the vehicle, merges dynamic information for guiding a movable object located on the optimal route into the field-of-view information for autonomous driving, and updates the optimal route based on the dynamic information.

In an embodiment, the processor may display the map information received from the server on a rollable display provided in the vehicle, determine that a size of a display region of the rollable display is changed, and request and receive map information to be displayed in the changed display region from the server based on the changed size of the display region.

In an embodiment, the processor may determine a size of an extended region when the size of the display region of the rollable display is enlarged.

In an embodiment, the processor may request and receive tile-based map information corresponding to the size of the extended region from the server, and display the received tile-based map information in the extended region.

In an embodiment, the processor may generate a lane-based optimal route corresponding to the received tile-based map information.

In an embodiment, the processor may control a rollable display of the vehicle to reflect and display the generated lane-based optimal route on the tile-based map information displayed in the extended region.

In an embodiment, when tile-based map information to be displayed in the changed display region is previously stored in a memory, the processor may extract tile-based map information to be displayed in the changed display region from the memory instead of requesting map information from the server, and display the extracted tile-based map information in the changed display region of the rollable display.

In an embodiment, when the size of the display region of the rollable display is enlarged, the processor may receive map information corresponding to the size of the extended region from the server to display the received map information, and generate a new tile-based optimal route that can be driven from the map information displayed in the extended region, and display the new optimal route on the map information displayed in the extended region.

In an embodiment, the processor may receive map information in units of a first number of tiles from the server and displays the received map information on the rollable display before the size of the display region of the rollable display is changed, and receive map information in units of a second number of tiles greater than the first number of tiles from the server and display the received map information on the rollable display so as to display the map information in the extended region when the display region of the rollable display is enlarged.

In an embodiment, the processor may display a graphic object that divides tile-based map information on the rollable display so as to identify the tile-based map information.

In an embodiment, when the display region of the rollable display is enlarged, the processor may receive only some layers among a plurality of layers constituting map information to be displayed in the extended region from the server and display the received some layers in the extended region.

In an embodiment, when the vehicle enters within a predetermined distance from a place corresponding to a predetermined point of map information displayed in the extended region, the processor may receive the remaining layer except for the some layers among the plurality of layers from the server to reflect the received remaining layers on the map information displayed in the extended region.

In an embodiment, when new map information is displayed in the extended region as the display region of the rollable display is enlarged, the processor may extend a sensing range of a sensor of a vehicle that senses information in a direction corresponding to a direction in which the new map information is displayed.

In an embodiment, the processor may display at least one of map information and an optimal route on the rollable display in a different manner based on a size of a display region of the rollable display.

In an embodiment, while the rollable display displays map information in a display region having a first size, the processor may control the rollable display to be enlarged to a second size larger than the first size when an event occurs at a point out of the map information displayed in the display region having the first size.

In an embodiment, the processor may determine the second size based on a point at which the event occurs.

### Advantageous Effects of Invention

The effects of a route provision apparatus according to the present disclosure and a route provision method therefor will be described as follows.

First, the present disclosure may provide a route provision apparatus optimized for generating or updating field-of-view information for autonomous driving.

Second, the present disclosure may provide a route provision apparatus capable of providing optimized map information and route information by utilizing a rollable display provided in a vehicle.

Third, the present disclosure may provide a user interface capable of utilizing an extended region in an optimized manner when the rollable display is enlarged by a user.

Fourth, the present disclosure provides a rollable display and a route provision apparatus to which a new control method capable of providing additional information in an optimized manner by enlarging the rollable display is applied when the additional information related to driving of a vehicle needs to be provided.

### BRIEF DESCRIPTION OF DRAWINGS

FIG. 1 is a view illustrating an appearance of a vehicle according to an embodiment of the present disclosure.

FIG. 2 is a view in which a vehicle according to an embodiment of the present disclosure is viewed at various angles from the outside.

FIGS. 3 and 4 are views illustrating an inside of a vehicle according to an embodiment of the present disclosure.

FIGS. 5 and 6 are views referenced to describe objects according to an embodiment of the present disclosure.

FIG. 7 is a block diagram referenced to describe a vehicle according to an embodiment of the present disclosure.

FIG. 8 is a conceptual view for explaining an electronic horizon provider (EHP) associated with the present disclosure.

FIG. 9 is a block diagram for explaining the route provision apparatus of FIG. 8 in more detail.

FIG. 10 is a conceptual view for explaining eHorizon associated with the present disclosure.

FIGS. 11A and 11B are conceptual views for explaining an LDM (Local Dynamic Map) and an ADAS (Advanced Driver Assistance System) MAP associated with the present disclosure.

FIGS. 12A and 12B are exemplary views for explaining a method of receiving high-definition map data by a route driving device according to an embodiment of the present disclosure.

FIG. 13 is a flowchart for explaining a method of allowing a route provision apparatus to receive a high-definition map and generate field-of-view information for autonomous driving.

FIG. 14 is a conceptual view for explaining a processor included in a route provision apparatus according to the present disclosure.

FIG. 15 is a conceptual view for explaining the concept of a route provision apparatus and a rollable display of the present disclosure.

FIG. 16 is a flowchart for explaining a representative control method of the present disclosure.

FIGS. 17, 18, 19, 20, 21 and 22 are conceptual views for explaining a control method illustrated in FIG. 16.

FIGS. 23, 24, 25, 26, and 27 are conceptual views for explaining an embodiment in which a rollable display is enlarged under the control of a route provision apparatus.

FIG. 28 is a perspective view showing a vehicle display device according to an embodiment.

FIG. 29 is a perspective view showing the vehicle display device whose state is changed in FIG. 28.

FIG. 30 is a front view showing a vehicle display device according to an embodiment.

FIG. 31 is a cross-sectional view in which a portion A-A of FIG. 30 is viewed in a direction shown.

FIG. 32 is a view in which a portion B-B of FIG. 30 is viewed in a direction shown.

FIG. 33 is a front view showing the vehicle display device whose state is changed in FIG. 30.

FIG. 34 is a cross-sectional view in which a portion A-A of FIG. 33 is viewed in a direction shown.

FIG. 35 is a perspective view showing some elements of a vehicle display device according to an embodiment.

FIG. 36 is a perspective view showing the vehicle display device whose state is changed in FIG. 35.

### MODE FOR THE INVENTION

Hereinafter, the embodiments disclosed herein will be described in detail with reference to the accompanying drawings, and the same or similar elements are designated with the same numeral references regardless of the numerals in the drawings and their redundant description will be omitted. A suffix “module” or “unit” used for elements disclosed in the following description is merely intended for easy description of the specification, and the suffix itself is not intended to give any special meaning or function. In describing the embodiments disclosed herein, moreover, the detailed description will be omitted when specific description for publicly known technologies to which the invention pertains is judged to obscure the gist of the present disclosure. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. On the other hand, when an element is referred to as being “directly connected with” another element, there are no intervening elements present.

A singular representation may include a plural representation unless it represents a definitely different meaning from the context.

Terms “include” or “has” used herein should be understood that they are intended to indicate the existence of a feature, a number, a step, an element, a component or a combination thereof disclosed in the specification, and it may also be understood that the existence or additional possibility of one or more other features, numbers, steps, elements, components or combinations thereof are not excluded in advance.

A vehicle according to an embodiment of the present disclosure may be understood as a conception including cars, motorcycles and the like. Hereinafter, the vehicle will be described based on a car.

The vehicle according to the embodiment of the present disclosure may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

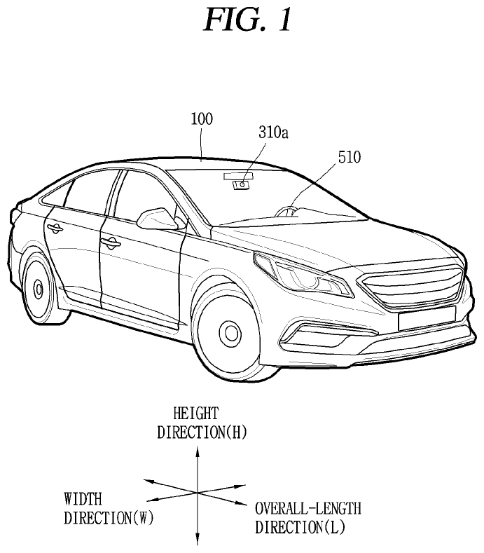

FIG. 1 is a view illustrating an appearance of a vehicle according to an embodiment of the present disclosure.

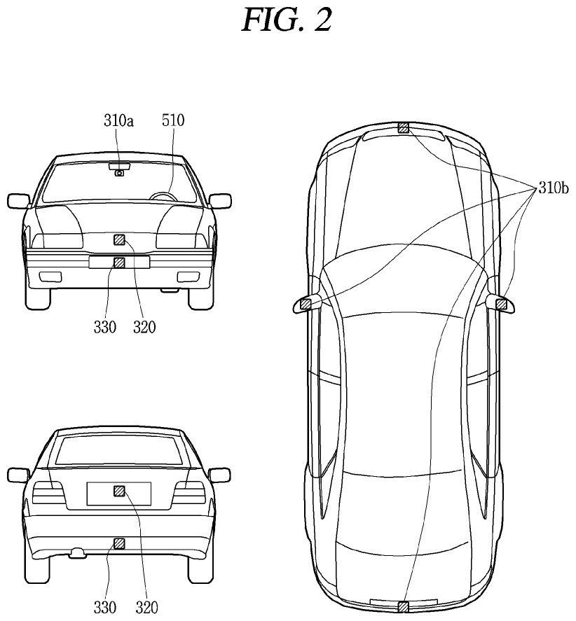

FIG. 2 is a view in which a vehicle according to an embodiment of the present disclosure is viewed at various angles from the outside.

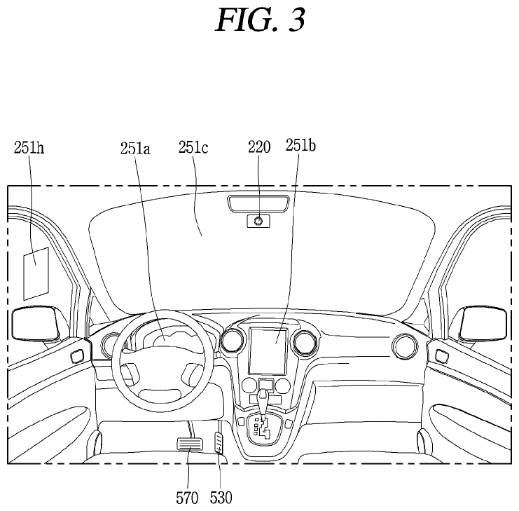

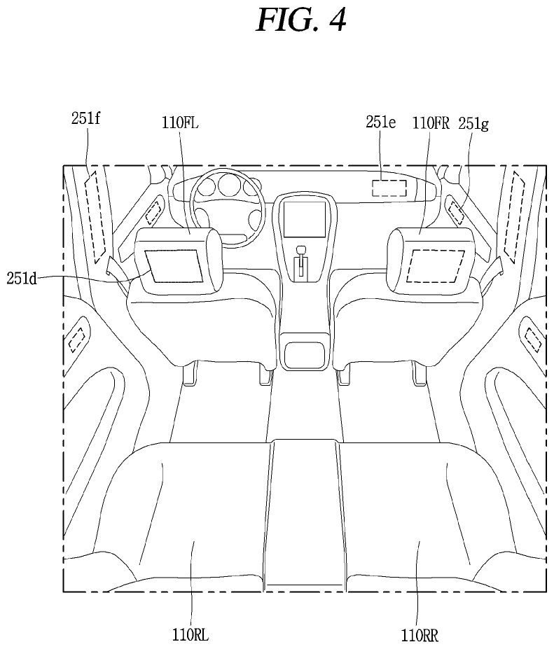

FIGS. 3 and 4 are views illustrating an inside of a vehicle according to an embodiment of the present disclosure.

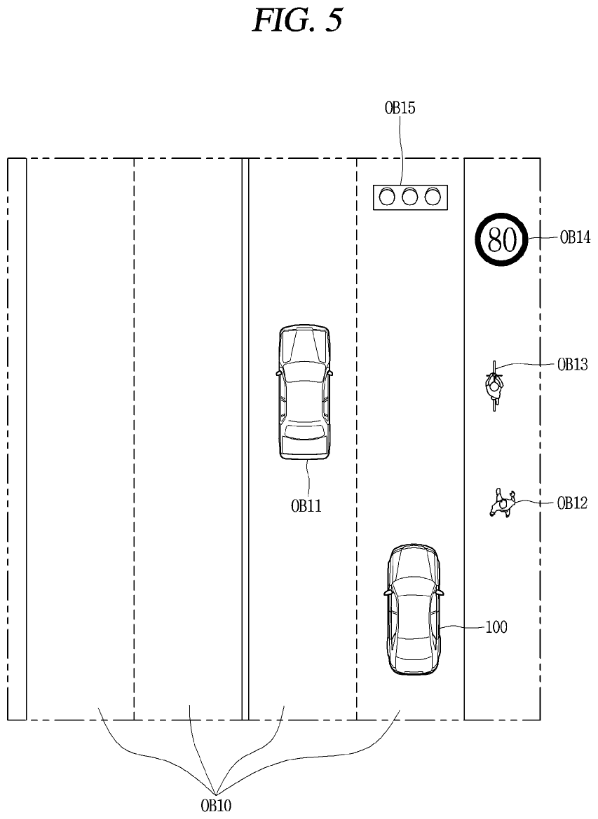

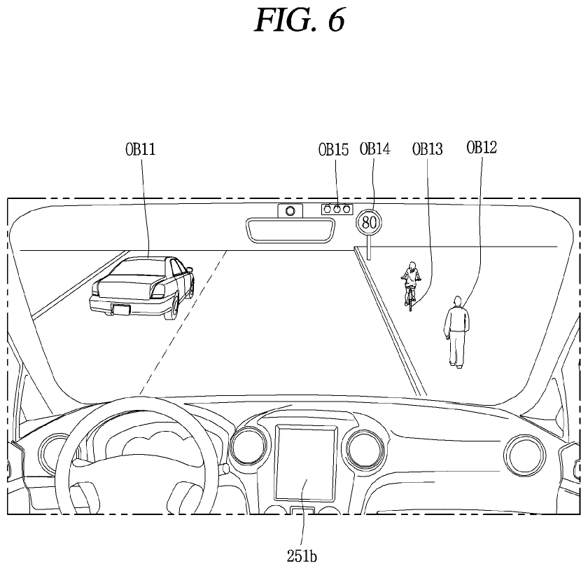

FIGS. 5 and 6 are views referenced to describe objects according to an embodiment of the present disclosure.

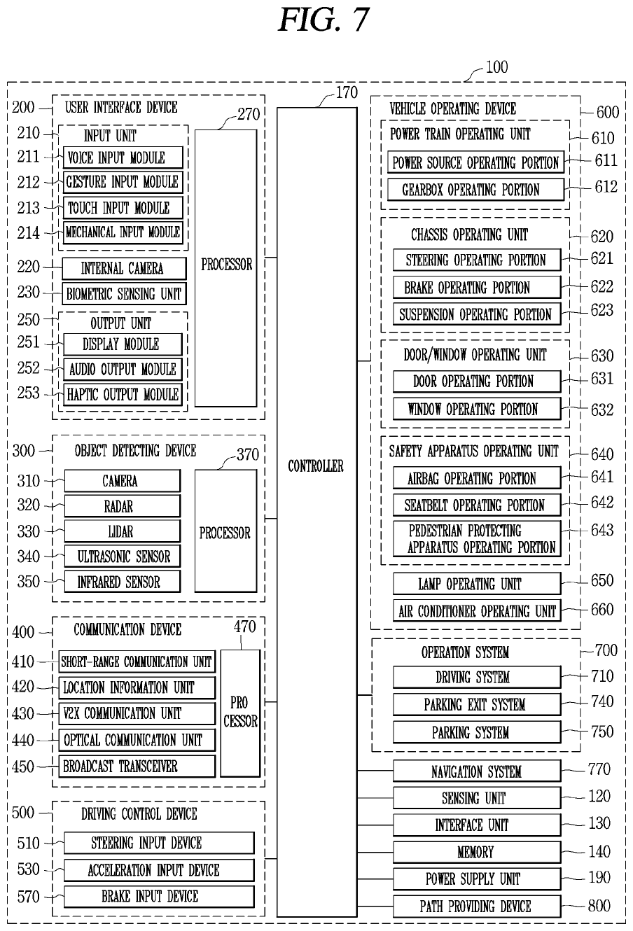

FIG. 7 is a block diagram referenced to describe a vehicle according to an embodiment of the present disclosure.

Referring to FIGS. 1 through 7, a vehicle 100 may include wheels turning by a driving force, and a steering apparatus 510 for adjusting an advancing direction of the vehicle 100.

The vehicle 100 may be an autonomous vehicle.

The vehicle 100 may be switched to an autonomous mode or a manual mode based on a user input.

For example, the vehicle may be switched from the manual mode to the autonomous mode or from the autonomous mode to the manual mode based on a user input received through a user interface apparatus 200.

The vehicle 100 may be switched to the autonomous mode or the manual mode based on driving environment information. The driving environment information may be generated based on object information provided from an object detecting apparatus 300.

For example, the vehicle 100 may be switched from the manual mode to the autonomous driving mode or from the autonomous driving mode to the manual mode based on driving environment information generated in the object detecting apparatus 300.

For example, the vehicle 100 may be switched from the manual mode to the autonomous driving mode or from the autonomous driving mode to the manual mode based on driving environment information received through a communication apparatus 400.

The vehicle 100 may be switched from the manual mode to the autonomous driving mode or from the autonomous driving mode to the manual mode based on information, data or signal provided from an external device.

When the vehicle 100 is driven in the autonomous mode, the autonomous vehicle 100 may be driven based on an operation system 700.

For example, the autonomous vehicle 100 may be driven based on information, data or signal generated in a driving system 710, a parking exit system 740 and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 7, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, a vehicle interface unit 130, a memory 140, a controller 170 and a power supply unit 190.

According to embodiments, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 200 may implement user interfaces (UIs) or user experiences (UXs) through the user interface apparatus 200.

The user interface apparatus 200 may include an input unit 210, an internal camera 220, a biometric sensing unit 230, an output unit 250 and a processor 270.

According to embodiments, the user interface apparatus 200 may include more components in addition to components to be explained in this specification or may not include some of those components to be explained in this specification.

The input unit 200 may allow the user to input information. Data collected in the input unit 120 may be analyzed by the processor 270 and processed as a user's control command.

The input unit 210 may be disposed within the vehicle. For example, the input unit 200 may be disposed on one region of a steering wheel, one region of an instrument panel, one region of a seat, one region of each pillar, one region of a door, one region of a center console, one region of a headlining, one region of a sun visor, one region of a wind shield, one region of a window or the like.

The input unit 210 may include a voice input module 211, a gesture input module 212, a touch input module 213, and a mechanical input module 214.

The audio input module 211 may convert a user's voice input into an electric signal. The converted electric signal may be provided to the processor 270 or the controller 170.

The voice input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

According to embodiments, the gesture input module 212 may detect a user's three-dimensional gesture input. To this end, the gesture input module 212 may include a light emitting diode outputting a plurality of infrared rays or a plurality of image sensors.

The gesture input module 212 may detect the user's three-dimensional gesture input by a time-of-flight (TOF) scheme, a structured light scheme or a disparity scheme.

The touch input module 213 may convert the user's touch input into an electric signal. The converted electric signal may be provided to the processor 270 or the controller 170.

The touch input module 213 may include a touch sensor for detecting the user's touch input.

According to an embodiment, the touch input module 213 may be integrated with a display module 251 so as to implement a touch screen. The touch screen may provide an input interface and an output interface between the vehicle 100 and the user.

The mechanical input module 214 may include at least one of a button, a dome switch, a jog wheel, and a jog switch. An electric signal generated by the mechanical input module 214 may be provided to the processor 270 or the controller 170.

The mechanical input module 214 may be arranged on a steering wheel, a center fascia, a center console, a cockpit module, a door and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing module 230 may include a sensor for detecting the user's biometric information and acquire fingerprint information and heart rate information regarding the user using the sensor. The biometric information may be used for user authentication.

The output unit 250 may generate an output related to a visual, auditory or tactile signal.

The output unit 250 may include at least one of a display module 251, an audio output module 252 and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a transparent TFEL (Thin Film Electroluminescent), a transparent OLED (Organic Light-Emitting Diode), a transparent LCD (Liquid Crystal Display), a transmissive transparent display, and a transparent LED (Light Emitting Diode) display. The transparent display may have adjustable transparency.

Meanwhile, the user interface apparatus 200 may include a plurality of display modules 251a to 251g.

The display module 251 may be disposed on one region of a steering wheel, one region 521a, 251b, 251e of an instrument panel, one region 251d of a seat, one region 251f of each pillar, one region 251g of a door, one region of a center console, one region of a headlining or one region of a sun visor, or implemented on one region 251c of a windshield or one region 251h of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The processor 270 may control an overall operation of each unit of the user interface apparatus 200.

According to an embodiment, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

Meanwhile, the user interface apparatus 200 may be referred to as a vehicle display device.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

Referring to FIGS. 5 and 6, an object O may include a traffic lane OB10, another vehicle OB11, a pedestrian OB12, a two-wheeled vehicle OB13, traffic signals OB14 and OB15, light, a road, a structure, a speed hump, a geographical feature, an animal and the like.

The lane OB01 may be a driving lane, a lane next to the driving lane or a lane on which another vehicle comes in an opposite direction to the vehicle 100. The lanes OB10 may be a concept including left and right lines forming a lane.

The other vehicle OB11 may be a vehicle which is moving around the vehicle 100. The other vehicle OB11 may be a vehicle located within a predetermined distance from the vehicle 100. For example, the other vehicle OB11 may be a vehicle which moves before or after the vehicle 100.

The pedestrian OB12 may be a person located in the vicinity of the vehicle 100. The pedestrian OB12 may be a person located within a predetermined distance from the vehicle 100. For example, the pedestrian OB12 may be a person located on a sidewalk or roadway.

The two-wheeled vehicle OB13 may refer to a vehicle (transportation facility) that is located near the vehicle 100 and moves using two wheels. The two-wheeled vehicle OB13 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

The light may be light emitted from a lamp provided on another vehicle. The light may be light generated by a streetlamp. The light may be solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge and the like.

The geographical feature may include a mountain, a hill and the like.

Meanwhile, objects may be classified into a moving object and a fixed object. For example, the moving object may be a concept including another vehicle and a pedestrian. The fixed object may be a concept including a traffic signal, a road and a structure.

The object detecting apparatus 300 may include a camera 310, a radar 320, a lidar 330, an ultrasonic sensor 340, an infrared sensor 350 and a processor 370.

According to an embodiment, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an AVM (Around View Monitoring) camera 310b, or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk or a tail gate.

For example, the camera 310 may be disposed adjacent to at least one of side windows within the vehicle to acquire a side image of the vehicle. Or, the camera 310 may be disposed adjacent to a side mirror, a fender or a door.

The camera 310 may provide an acquired image to the processor 370.

The radar 320 may include electromagnetic wave transmitters and receivers. The radar 320 may be implemented as a pulse radar scheme or a continuous wave radar scheme according to a principle of emitting radio waves. The radar 320 may be implemented by a Frequency Modulated Continuous Wave (FMCW) scheme or a Frequency Shift Keying (FSK) scheme according to a signal waveform in a continuous wave radar scheme.

The radar 320 may detect an object in a time of flight (TOF) manner or a phase-shift scheme through the medium of electromagnetic waves, and detect a position of the detected object, a distance from the detected object and a relative speed with the detected object.

The radar 320 may be disposed on an appropriate location outside the vehicle for detecting an object which is located at a front, rear or side of the vehicle.

The lidar 330 may include laser transmitters and receivers. The lidar 330 may be implemented in a time-of-flight (TOF) scheme or a phase-shift scheme.

The lidar 330 may be implemented as a drive type or a non-drive type.

For the drive type, the lidar 330 may be rotated by a motor and detect object near the vehicle 100.

For the non-drive type, the lidar 330 may detect, through light steering, objects which are located within a predetermined range based on the vehicle 100. The vehicle 100 may include a plurality of non-drive type lidars 330.

The lidar 330 may detect an object in a time-of-flight (TOF) scheme or a phase-shift scheme through the medium of laser light, and detect a position of the detected object, a distance from the detected object and a relative speed with the detected object.

The lidar 330 may be disposed on an appropriate location outside the vehicle for detecting an object located at the front, rear or side of the vehicle.

The ultrasonic sensor 340 may include ultrasonic wave transmitters and receivers. The ultrasonic sensor 340 may detect an object based on an ultrasonic wave, and detect a location of the detected object, a distance from the detected object and a relative speed with the detected object.

The ultrasonic sensor 340 may be disposed on an appropriate location outside the vehicle for detecting an object located at the front, rear or side of the vehicle.

The infrared sensor 350 may include infrared light transmitters and receivers. The infrared sensor 340 may detect an object based on infrared light, and detect a location of the detected object, a distance from the detected object and a relative speed with the detected object.

The infrared sensor 350 may be disposed on an appropriate location outside the vehicle for detecting an object located at the front, rear or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor 370 may detect an object based on reflected infrared light which emitted infrared light is reflected from the object, and track the object. The processor 370 may execute operations, such as a calculation of a distance from the object, a calculation of a relative speed with the object and the like, based on the infrared light.

According to an embodiment, the object detecting apparatus 300 may include a plurality of processors 370 or may not include any processor 370. For example, each of the camera 310, the radar 320, the lidar 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 400 may operate according to the control of the controller 170.

The communication apparatus 400 is an apparatus for performing communication with an external device. Here, the external device may be another vehicle, a mobile terminal or a server.

The communication apparatus 400 may perform the communication by including at least one of a transmitting antenna, a receiving antenna, and a radio frequency (RF) circuit and a RF device for implementing various communication protocols.

The communication apparatus 400 may include a short-range communication unit 410, a location information unit 420, a V2X communication unit 430, an optical communication unit 440, a broadcast transceiver 450 and a processor 470.

According to an embodiment, the communication apparatus 400 may further include other components in addition to the components described, or may not include some of the components described.

The short-range communication unit 410 is a unit for facilitating short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring location information. For example, the location information unit 420 may include a Global Positioning System (GPS) module or a Differential Global Positioning System (DGPS) module.

The V2X communication unit 430 is a unit for performing wireless communications with a server (vehicle to infrastructure; V2I), another vehicle (vehicle to vehicle; V2V), or a pedestrian (vehicle to pedestrian; V2P). The V2X communication unit 430 may include an RF circuit capable of implementing a communication protocol with an infrastructure (V2I), a communication protocol between vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an embodiment, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

According to an embodiment, the communication apparatus 400 may include a plurality of processors 470 or may not include any processor 470.

When the processor 470 is not included in the communication apparatus 400, the communication apparatus 400 may operate according to the control of a processor of another apparatus within the vehicle 100 or the controller 170.

Meanwhile, the communication apparatus 400 may implement a vehicle display device together with the user interface apparatus 200. In this instance, the vehicle display device may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding an advancing direction of the vehicle 100 from the user. The steering input device 510 is preferably configured in the form of a wheel allowing a steering input in a rotating manner. According to some embodiments, the steering input device may also be configured in a shape of a touch screen, a touchpad or a button.

The acceleration input device 530 may receive an input for accelerating the vehicle 100 from the user. The brake input device 570 may receive an input for braking the vehicle 100 from the user. Each of the acceleration input device 530 and the brake input device 570 is preferably configured in the form of a pedal. According to some embodiments, the acceleration input device or the brake input device may also be configured in the form of a touch screen, a touch pad or a button.

The driving control apparatus 500 may operate according to the control of the controller 170.

The vehicle operating apparatus 600 is an apparatus for electrically controlling operations of various apparatuses within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some embodiments, the vehicle operating apparatus 600 may further include other components in addition to the components described, or may not include some of the components described.

Meanwhile, the vehicle operating apparatus 600 may include a processor. Each unit of the vehicle operating apparatus 600 may individually include a processor.

The power train operating unit 610 may control an operation of a power train apparatus.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N) or parking (P).

Meanwhile, when an engine is the power source, the gearbox operating portion 612 may adjust a locked state of a gear in the drive (D) state.

The chassis operating unit 620 may control an operation of a chassis apparatus.

The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change an advancing direction of the vehicle.

The brake operating portion 622 may perform an electronic control for a brake apparatus within the vehicle 100. For example, the brake operating portion 622 may control an operation of brakes provided at wheels to reduce speed of the vehicle 100.

Meanwhile, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a curve is present on a road surface.

Meanwhile, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating portion 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may be operated in the autonomous driving mode.

The operation system 700 may include a driving system 710, a parking exit system 740 and a parking system 750.

According to embodiments, the operation system 700 may further include other components in addition to components to be described, or may not include some of the components to be described.

Meanwhile, the operation system 700 may include a processor. Each unit of the operation system 700 may individually include a processor.

Meanwhile, according to embodiments, the operation system may be a sub concept of the controller 170 when it is implemented in a software configuration.

Meanwhile, according to embodiment, the operation system 700 may be a concept including at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, route information according to the set destination, information regarding various objects on a route, lane information and current location information of the vehicle.

The navigation system 770 may include a memory and a processor. The memory may store the navigation information. The processor may control an operation of the navigation system 770.

According to embodiments, the navigation system 770 may update prestored information by receiving information from an external device through the communication apparatus 400.

According to embodiments, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a location (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The vehicle interface unit 130 may serve as a route allowing the vehicle 100 to interface with various types of external devices connected thereto. For example, the vehicle interface unit 130 may be provided with a port connectable with a mobile terminal, and connected to the mobile terminal through the port. In this instance, the vehicle interface unit 130 may exchange data with the mobile terminal.

Meanwhile, the vehicle interface unit 130 may serve as a route for supplying electric energy to the connected mobile terminal. When the mobile terminal is electrically connected to the vehicle interface unit 130, the vehicle interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be various storage apparatuses such as a ROM, a RAM, an EPROM, a flash drive, a hard drive, and the like in terms of hardware. The memory 140 may store various data for overall operations of the vehicle 100, such as programs for processing or controlling the controller 170.

According to embodiments, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each element according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

Meanwhile, the vehicle 100 according to the present disclosure may include a route provision apparatus 800.

The route provision apparatus 800 may control at least one of those elements illustrated in FIG. 7. From this perspective, the route provision apparatus 800 may be the controller 170.

However, the present disclosure is not limited thereto, and route provision apparatus 800 may be a separate configuration independent of the controller 170. When the route provision apparatus 800 is implemented as an element independent of the controller 170, the route provision apparatus 800 may be provided on a part of the vehicle 100.

Hereinafter, description will be given of an example that the route provision apparatus 800 is an element separate from the controller 170 for the sake of explanation. In the present specification, functions (operations) and control methods described in relation to the route provision apparatus 800 may be executed by the controller 170 of the vehicle. In other words, every detail described in relation to the route provision apparatus 800 may be applied to the controller 170 in the same/like manner.

Furthermore, the route provision apparatus 800 described herein may include some of the components illustrated in FIG. 7 and various elements included in the vehicle. For the sake of explanation, the elements illustrated in FIG. 7 and the various elements included in the vehicle will be described with separate names and reference numbers.

Hereinafter, a method of autonomously driving a vehicle associated with the present disclosure in an optimized manner or priding route information optimized for driving a vehicle will be described in more detail with reference to the accompanying drawings.

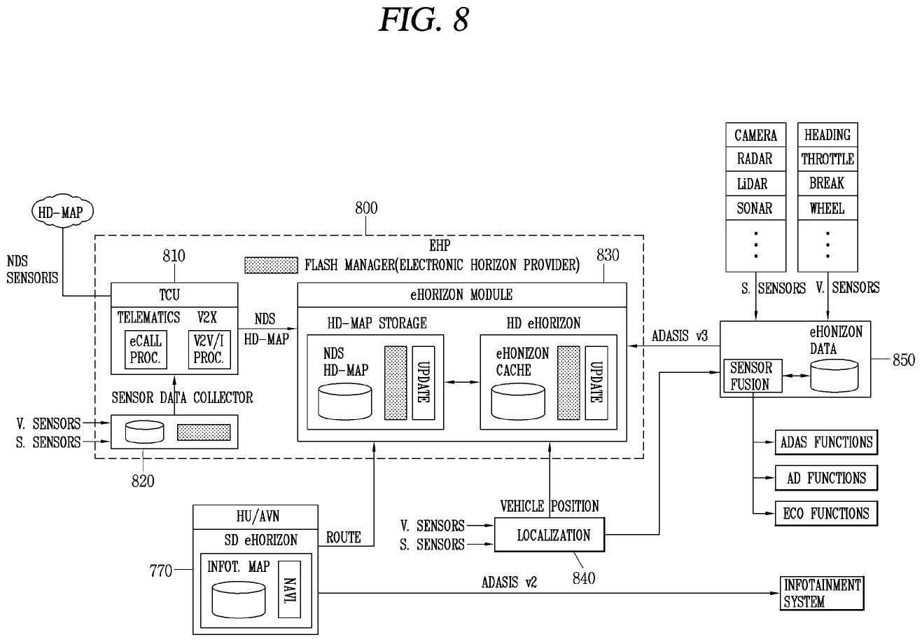

FIG. 8 is a conceptual view for explaining an electronic horizon provider (EHP) associated with the present disclosure.

Referring to FIG. 8, a map providing device 800 associated with the present disclosure may control a vehicle 100 on the basis of eHorizon.

The route provision apparatus 800 may include an EHP (Electronic Horizon Provider). The EHP may be referred to as a processor 830 in this specification.

Here, Electronic Horizon may be referred to as ‘ADAS Horizon’, ‘ADASIS Horizon’, ‘Extended Driver Horizon’ or ‘eHorizon’.

The eHorizon may be understood as software, a module, a device or a system that performs the role of generating a vehicle's forward route information using high-definition (HD) map data, configuring it based on a specified standard (protocol) (e.g., a standard specification defined by the ADAS), and transmitting the configured data to an application (e.g., an ADAS application, a map application, etc.) installed in a module (for example, an ECU, a controller 170, a navigation system 770, etc.) of the vehicle or in the vehicle requiring map information (or route information).

The device implementing an operation/function/control method performed by the eHorizon may be the processor 830 (EHP) and/or the route provision apparatus 800. In other words, the processor 830 may be provided with or include the eHorizon described in this specification.

In the past, the vehicle's forward route (or a route to the destination) has been provided as a single route based on a navigation map (or a route to the destination), but eHorizon may provide lane-based route information based on a high-definition (HD) map.

The data generated by eHorizon may be referred to as “electronic horizon data” or “eHorizon data” or “field-of-view information for autonomous driving” or an “ADASIS message.”

The electronic horizon data may be described with driving plan data used when generating a driving control signal of the vehicle 100 in a driving system. For example, the electronic horizon data may be understood as driving plan data within a range from a point where the vehicle 100 is located to a horizon (field-of-view) (a predetermined distance or destination).

Here, the horizon may be understood a range from a point where the vehicle 100 is located to a point in front of a predetermined distance on the basis of a preset driving route. The horizon may denote a point at which the vehicle 100 can reach after a preset period of time from a point where the vehicle 100 is located along a preset driving route. Here, the driving route may denote a driving route to a final destination or an optimal route on which the vehicle is expected to drive when the destination is not set. The destination may be set by a user input.

The electronic horizon data may include horizon map data and the horizon pass data. The horizon map data may include at least one of topology data, ADAS data, HD map data, and dynamic data. According to an embodiment, the horizon map data may include a plurality of layers. For example, the horizon map data may include a first layer matching (corresponding) to topology data, a second layer matched with ADAS data, a third layer matched with HD map data, and a fourth layer matched with dynamic data. The horizon map data may further include static object data.

The topology data may be described as a map created by connecting the center of the road. The topology data is suitable for roughly indicating the location of a vehicle, and may be in the form of data used primarily in navigation for a driver. The topology data may be understood as data on road information excluding information on lanes. The topology data may be generated based on data received at an infrastructure via V2I. The topology data may be based on data generated by the infrastructure. The topology data may be based on data stored in at least one memory provided in the vehicle 100.

The ADAS data may denote data related to road information. The ADAS data may include at least one of slope data of roads, curvature data of roads, and speed limit data of roads. The ADAS data may further include no overtaking section data. The ADAS data may be based on data generated by the infrastructure 20. The ADAS data may be based on data generated by the object detecting apparatus 210. The ADAS data may be referred to as road information data.

The HD map data may include topology information in a detailed lane unit of roads, connection information of each lane, feature information (e.g., traffic sign, lane marking/attribute, road furniture, etc.) for localization of a vehicle. The HD map data may be based on data generated by the infrastructure.

The dynamic data may include various dynamic information that can be generated on a road. For example, the dynamic data may include construction information, variable speed lane information, road surface state information, traffic information, moving object information, and the like. The dynamic data may be based on data received from the infrastructure 20. The dynamic data may be based on data generated by the object detecting apparatus 210.

The route provision apparatus 800 may provide map data within a range from a point where the vehicle 100 is located to a horizon. The horizon pass data may be described as a trajectory that can be taken by the vehicle 100 within a range from a point where the vehicle 100 is located to a horizon. The horizon pass data may include data indicating a relative probability of selecting any one road at a decision point (e.g., a crossroad, a junction, an intersection, etc.). The relative probability may be calculated based on time taken to arrive at the final destination. For example, when the time taken to arrive at the final destination in case of selecting a first road is shorter than that in case of selecting a second road at a decision point, the probability of selecting the first road may be calculated higher than that of selecting the second road.

The horizon pass data may include a main route and a sub route. The main route may be understood as a trajectory connecting roads with a relatively high probability of being selected. The sub route may be branched from at least one decision point on the main route. The sub route may be understood as a trajectory connecting at least any one road having a low relative probability of being selected on at least one decision point on the main route.

The main route may be referred to as an optimal route in the present specification, and the sub route may be referred to as a sub route.

eHorizon may be classified into categories such as software, a system, a concept, and the like. The eHorizon denotes a configuration in which road shape information on a high-definition map under a connected environment such as an external server (cloud server), V2X (vehicle to everything) or the like and real-time events and dynamic information on dynamic objects such as real-time traffic signs, road surface conditions, accidents and the like are merged to provide relevant information to autonomous driving systems and infotainment systems.

In other words, eHorizon may perform the role of transferring a precision map road shape and real time events in front of the vehicle to autonomous driving systems and infotainment systems under an external server/V2X environment.

In order to effectively transfer eHorizon data (electronic horizon data or field-of-view information for autonomous driving) transmitted (generated) from the eHorizon to autonomous driving systems and infotainment systems, a data specification and transmission method may be formed in accordance with a standard called “ADASIS (Advanced Driver Assistance Systems Interface Specification).”

The vehicle control device 100 associated with the present disclosure may use information received (generated) from eHorizon for autonomous driving systems and/or infotainment systems.

For example, an autonomous navigation system may use information provided by eHorizon data provided by eHorizon in the safety and ECO aspects.

In terms of the safety aspect, the vehicle 100 (or route provision apparatus 800) according to the present disclosure may perform an ADAS (Advanced Driver Assistance System) function such as LKA (Lane Keeping Assist), TJA (Traffic Jam Assist) or the like, and/or an AD (AutoDrive) function such as advance, road joining, lane change or the like using road shape information and event information received from eHorizon and surrounding object information sensed through the sensing unit 840 provided in the vehicle.

Furthermore, in terms of the ECO aspect, the vehicle 100 (or route provision apparatus 800) may receive inclination information, traffic light information, and the like on a front road from eHorizon to control the vehicle so as to achieve efficient engine output, thereby enhancing fuel efficiency.

The infotainment system may include convenience aspects.

For an example, the vehicle 100 (or route provision apparatus 800) may receive accident information, road surface condition information, and the like on a front road received from eHorizon to output them on a display module (for example, HUD (Head Up Display), CID, Cluster, etc.) provided in the vehicle to provide guide information for allowing the driver to perform safe driving.

The eHorizon may receive the location information of various event information (e.g., road surface condition information, construction information, accident information, etc.) generated from a road and/or road specific speed limit information from the present vehicle 100 or other vehicles or collect them from an infrastructure (e.g., a measuring device, a sensing device, a camera, etc.) installed on a road.

Furthermore, the event information and the road specific speed limit information may be linked to map information or may be updated.

In addition, the location information of the event information may be divided into units of lanes.

Using the information, the eHorizon (or EHP) of the present disclosure may provide information required for autonomous driving system and infotainment systems to each vehicle based on a precision map capable of determining a road environment (or road information) in units of lanes.

In other words, the Electronic Horizon Provider (EHP) (eHorizon Provider) of the present disclosure may provide an absolute high-definition map using an absolute coordinate of information (for example, event information, location information of the present vehicle 100, etc.) associated with a road based on a high-definition map.

The information associated with a road provided by the eHorizon may be provided with information provided within a predetermined region (predetermined space) with respect to the present vehicle 100.

The EHP (Electronic Horizon Provider) may be understood as an element included in the eHorizon system to perform a function provided by the eHorizon (or eHorizon system).

The route provision apparatus 800 of the present disclosure may be an EHP, as illustrated in FIG. 8.

The route provision apparatus 800 (EHP) of the present disclosure may receive a high-definition map from an external server (or cloud server), generate route information to a destination in units of lanes, and transmit the high-definition map and the route information generated in units of lanes to a module or application (or program) of a vehicle that needs the map information and route information.

Referring to FIG. 8, the overall structure of the electronic horizon system of the present disclosure is illustrated in FIG. 8.

The route provision apparatus 800 of the present disclosure may include a telecommunication control unit (TCU) 810 for receiving a high-definition (HD) map existing in a cloud server.

The telecommunication control unit 810 may be a communication apparatus 400 described above, and may include at least one of elements included in the communication apparatus 400.

The telecommunication control unit 810 may include a telematics module or a V2X (vehicle to everything) module.

The telecommunication control unit 810 may receive a high-definition (HD) map according to the Navigation Data Standard (NDS) (or conforming to the NDS standard) from a cloud server.

In addition, the high-definition (HD) map may be updated by reflecting data sensed through a sensor provided in a vehicle and/or a sensor installed on an adjacent road according to a sensor ingestion interface specification (SENSORIS) which is a sensor ingestion interface specification.

The telecommunication control unit 810 may download a HD-map from a cloud server through the telematics module or the V2X module.

The map providing device 800 of the present disclosure may include an interface unit 820. The interface unit 820 receives sensing information from one or more sensors provided in the vehicle 100.

The interface unit 820 may be referred to as a sensor data collector.

The interface unit 820 may collect (receive) information sensed through sensors (for example, sensors (V. sensors) (e.g., heading, throttle, break, wheel, etc.) for sensing the operation of a vehicle) and sensors (S. sensors) (e.g., camera, radar, LiDAR, sonar, etc.) for sensing the surrounding information of a vehicle).

The interface unit 820 may transmit the information sensed through the sensors provided in a vehicle to the telecommunication control unit 810 (or the processor 830) to reflect the information on the high-definition map.

The telecommunication control unit 810 may update the high-definition map stored in the cloud server by transmitting the information transmitted from the interface unit 820 to the cloud server.

The route provision apparatus 800 of the present disclosure may include a processor 830 (or an eHorizon module) (EHP).

In the present specification, the EHP may be the route provision apparatus 800 or the processor 830.

The processor 830 may control the telecommunication control unit 810 and the interface unit 820.

The processor 830 may store a high-definition map received through the telecommunication control unit 810, and update the high-definition map using information received through the interface unit 820. Such an operation may be carried out in the storage unit of the processor 830.

The processor 830 may receive first route information from an AVN (Audio Video Navigation) or a navigation system 770.

The first route information, as route information provided in the related art, may be information for guiding a driving route to a destination.

At this time, the first route information provided in the related art provides only one route information, and does not distinguish lanes. The first route information may merely guide a road through which the vehicle must drive (pass) in order to reach a destination, but may not guide which lane to drive in the relevant road.

On the other hand, when the processor 830 receives the first route information, the processor 830 may generate second route information for guiding a driving route to a destination set in the first route information in units of lanes using a high-definition (HD) map and the first route information. Such an operation may be carried out in the operation unit 834 of the processor 830, for an example.

In addition, the eHorizon system may include a localization unit 840 for locating a vehicle using information sensed through sensors (V. sensors, S. sensors) provided in the vehicle.

The localization unit 840 may transmit the location information of the vehicle to the processor 830 so as to match (map) to the location of the vehicle detected using the sensors provided in the vehicle with the high-definition map.

The processor 830 may match the location of the vehicle 100 to the high-definition map based on the location information of the vehicle. Meanwhile, the localization unit 840 may, on its own, match (map) to the current location of the vehicle to a high-definition map based on the location information of the vehicle.

The processor 830 may generate electronic horizon data. Furthermore, the processor 830 may generate horizon pass data.

The processor 830 may generate the electronic horizon data by reflecting the driving environment of the vehicle 100. For example, the processor 830 may generate the electronic horizon data based on the driving direction data and the driving speed data of the vehicle 100.

The processor 830 may merge the generated electronic horizon data with previously generated electronic horizon data. For example, the processor 830 may positionally connect horizon map data generated at a first time point with horizon map data generated at a second time point. For example, the processor 830 may positionally connect horizon pass data generated at a first time point with horizon pass data generated at a second time point.

The processor 830 may include a memory, an HD map processing unit, a dynamic data processing unit, a matching unit, and a route generation unit.

The HD map processing unit may receive HD map data from a server via the communication device. The HD map processing unit may store the HD map data. According to an embodiment, the HD map processing unit may process and refine the HD map data. The dynamic data processing unit may receive dynamic data from the object detecting apparatus. The dynamic data processing unit may receive dynamic data from the server. The dynamic data processing unit may store dynamic data. According to an embodiment, the dynamic data processing unit 172 may process and refine the dynamic data.

The matching unit may receive a HD map from the HD map processing unit 171. The matching unit may receive dynamic data from the dynamic data processing unit. The matching unit may generate horizon map data by matching the HD map data and the dynamic data.

According to an embodiment, the matching unit may receive topology data. The matching unit may ADAS data. The matching unit may generate horizon map data by matching the topology data, the ADAS data, the HD map data, and the dynamic data. The route generation unit may generate horizon pass data. The route generation unit may include a main route generation unit and a sub route generation unit. The main route generation unit may generate main pass data.

The sub route generation unit may generate sub pass data.

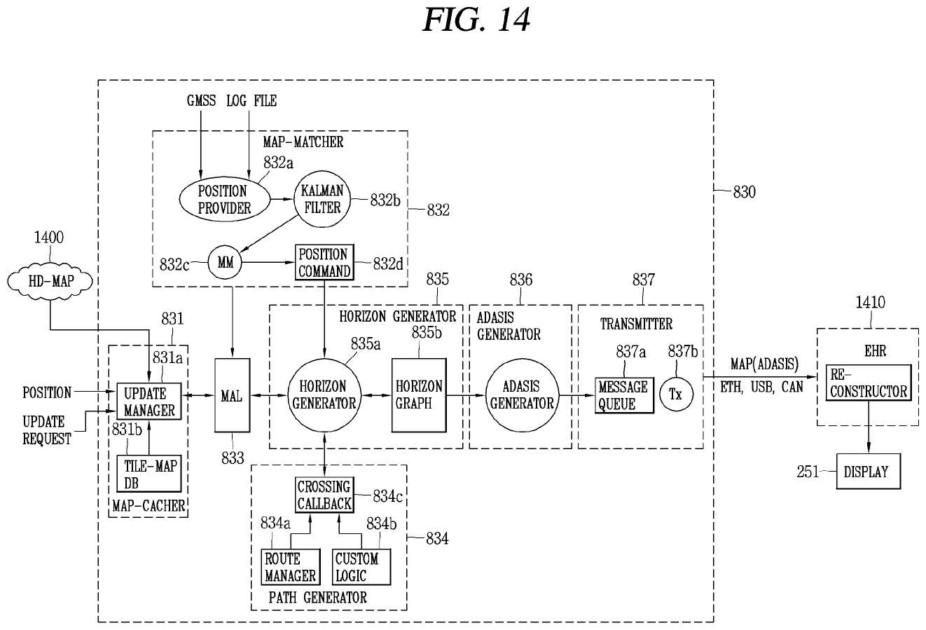

The specific structure of the processor 830 (EHP) will be described later in more detail with reference to FIG. 14.

Furthermore, the eHorizon system may include a merge unit 1590 that merges information (data) sensed by sensors provided in the vehicle with eHorizon data formed by the eHorizon module (controller).

For example, the merge unit 1590 may update a high-definition map by merging sensor data sensed in the vehicle to a high-definition map corresponding to eHozion data, and provide the updated high-definition map to an ADAS function, an AD (AutoDrive) function or an ECO function.

For an example, the processor 830 may generate/update dynamic information based on the sensor data.

The merge unit 1590 (or processor 830) may merge the dynamic information into electronic horizon data (field-of-view information for autonomous driving).

In addition, although not shown, the merge unit 1590 may also provide the updated high-definition map to the infotainment system.

In FIG. 8, it is illustrated that the route provision apparatus 800 (EHP) of the present disclosure includes only the telecommunication control unit 810, the interface unit 820, and the processor 830, but the present disclosure is not limited thereto.

The route provision apparatus 800 of the present disclosure may further include at least one of a localization unit 840 and a merge unit 1590.

In addition, the route provision apparatus 800 (EHP) of the present disclosure may further include a navigation system 770.

Through the above arrangement, when at least one of the localization unit 840, the merge unit 1590, and the navigation system 770 is included in the route provision apparatus 800 (EHP) of the present disclosure, it may be understood that the function/operation/control carried out by the component included therein is carried out by the processor 830.

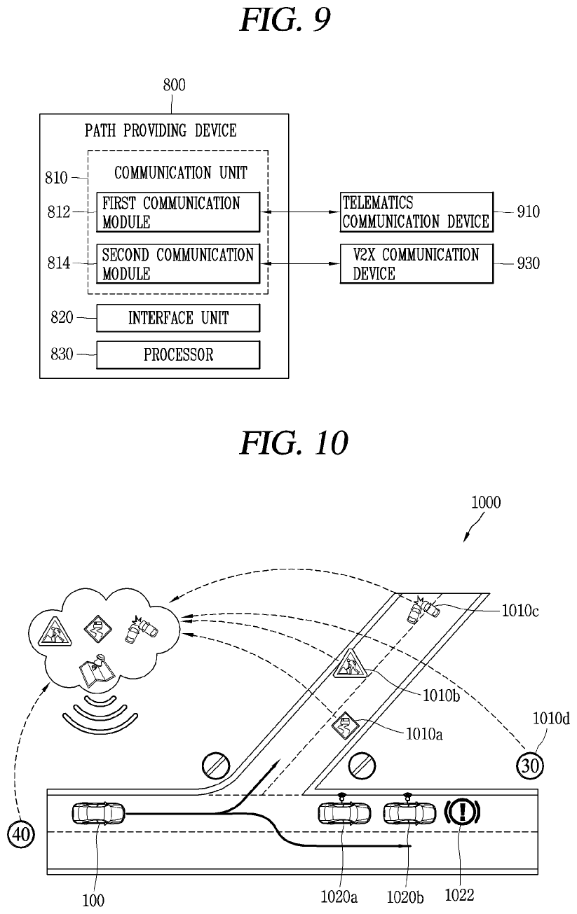

FIG. 9 is a block diagram for explaining the route provision apparatus of FIG. 8 in more detail.

The route provision apparatus denotes a device for providing a route to a vehicle. In other words, the route provision apparatus may generate and output a route on which the vehicle drives so as to recommend/provide the route on which the vehicle drives to a driver on board the vehicle.

Furthermore, the route provision apparatus may be a device mounted on a vehicle to perform communication via CAN communication, and generate a message for controlling a vehicle and/or an electrical part mounted on the vehicle (or an electrical part provided in the vehicle). Here, the electrical part mounted on the vehicle may denote various elements provided in the vehicle described with reference to FIGS. 1 through 8.

As described above, the message may denote an ADASIS message in which data generated by eHorizon is generated according to the ADASIS standard specification.

For another example, the route provision apparatus may be located outside the vehicle, such as a server or a communication device, to communicate with the vehicle through a mobile communication network. In this case, the route provision apparatus may remotely control the vehicle and/or the electrical part mounted on the vehicle using the mobile communication network.

The route provision apparatus 800 is provided in the vehicle, and may be configured with an independent device that is attachable and detachable from the vehicle, or may be a component of the vehicle installed integrally with the vehicle.

Referring to FIG. 9, the route provision apparatus 800 includes a telecommunication control unit 810, an interface unit 820, and a processor 830.

The telecommunication control unit 810 is configured to perform communication with various elements provided in the vehicle.

For an example, the telecommunication control unit 810 may receive various information provided through a controller area network (CAN).

The telecommunication control unit 810 includes a first telecommunication control unit 812, and the first telecommunication control unit 812 may receive a high-definition map provided through telematics. In other words, the first telecommunication control unit 812 performs ‘telematics communication’. The telematics communication may perform communication with a server or the like using a satellite navigation system satellite or a base station provided by mobile communication such as 4G and 5G.

The first telecommunication control unit 812 may perform communication with a telematics communication device 910. The telematics communication device may include a server provided by a portal provider, a vehicle provider, and/or a mobile communication company.

The processor 840 of the route provision apparatus 800 of the present disclosure may determine the absolute coordinates of information (event information) related to a road based on the ADAS MAP received from an external server (eHorizon) through the eHorizon module 812. In addition, the processor 830 may perform autonomous driving or vehicle control on the present vehicle using the absolute coordinates of information (event information) related to the road.

The telecommunication control unit 810 includes a second telecommunication control unit 814, and the second telecommunication control unit 814 may receive various information provided through V2X (vehicle to everything). In other words, the second telecommunication control unit 814 is configured to perform ‘V2X communication’. V2X communication may be defined as a technology that exchanges information such as traffic environment while communicating with road infrastructure and other vehicles while driving.

The second telecommunication control unit 814 may perform communication with a V2X communication device 930. The V2X communication device may include a mobile terminal possessed by a pedestrian or a bicycle rider, a stationary terminal installed on a road, another vehicle, and the like.

Here, the other vehicle may denote at least one of vehicles existing within a predetermined distance with respect to the present vehicle 100 or vehicles entering a predetermined distance with respect to the present vehicle 100.

The present disclosure may not be necessarily limited thereto, and the other vehicle may include all vehicles capable of communicating with the telecommunication control unit 810. In the present specification, for the sake of convenience of explanation, a case where the nearby vehicle exists within a predetermined distance from the present vehicle 100 or enters within the predetermined distance will be described as an example.

The predetermined distance may be determined based on a communicable distance through the telecommunication control unit 810, determined according to the specification of a product, or may be determined or varied based on a user's setting or the standard of V2X communication.

The second telecommunication control unit 814 may be formed to receive LDM data from another vehicle. The LDM data may be a V2X message (BSM, CAM, DENM, etc.) transmitted and received between vehicles through V2X communication.

The LDM data may include the location information of another vehicle.

Based on the location information of the present vehicle and the location information of another vehicle included in LDM data received through the second telecommunication control unit 814, the processor 830 may determine a relative location between the present vehicle and another vehicle.

Furthermore, the LDM data may include the speed information of another vehicle. The processor 830 may also determine a relative speed of another vehicle using the speed information of the present vehicle and the speed information of the other vehicle. The speed information of the present vehicle may be calculated using a degree to which the location information of the vehicle changes over time or calculated based on information received from the driving control apparatus 500 or the power train operating unit 610 of the vehicle 100.

The second telecommunication control unit 814 may be the V2X communication unit 430 described above.

If the telecommunication control unit 810 is a component that communicates with a device located outside the vehicle 100 using wireless communication, the interface unit 820 is an element that communicates with a device located inside the vehicle 100 using wired or wireless communication.

The interface unit 820 may receive information related to the driving of the vehicle from most of the electrical parts provided in the vehicle. Information transmitted from an electrical part provided in the vehicle 100 to the route provision apparatus 800 is referred to as ‘vehicle driving information.’

For an example, when the electrical part is a sensor, the vehicle driving information may be sensing information sensed by the sensor.

The vehicle driving information includes vehicle information and surrounding information of the vehicle. The information related to an inside of the vehicle with respect to the frame of the vehicle 100 may be defined as vehicle information, and the information related to an outside of the vehicle may be defined as surrounding information.

Vehicle information denotes information on the vehicle itself. For example, the vehicle information may include at least one of a driving speed of the vehicle, a driving direction, an acceleration, an angular speed, a position (GPS), a weight, a number of vehicle occupants, a braking force of the vehicle, a maximum braking force of the vehicle, an air pressure of each wheel, a centrifugal force applied to the vehicle, a driving mode of the vehicle (whether it is an autonomous driving mode or a manual driving mode), a parking mode of the vehicle (autonomous parking mode, automatic parking mode, manual parking mode), whether or not a user is on board the vehicle, information related to the user, and the like.

The surrounding information denotes information relate to another object located within a predetermined range around the vehicle and information related to the outside of the vehicle. The surrounding information of the vehicle may be a state of road surface (frictional force) on which the vehicle is traveling, weather, a distance from a front-side (rear-side) vehicle, a relative speed of a front-side (rear-side) vehicle, a curvature of curve when a driving lane is the curve, an ambient brightness of the vehicle, information associated with an object existing in a reference region (predetermined region) based on the vehicle, whether or not an object enters (or leaves) the predetermined region, whether or not a user exists around the vehicle, and information associated with the user (for example, whether or not the user is an authenticated user), and the like.

In addition, the surrounding information may include an ambient brightness, a temperature, a sun position, surrounding object information (a person, a vehicle, a sign, etc.), a type of road surface during driving, a geographic feature, line information, driving lane Information, and information required for autonomous driving/autonomous parking/automatic parking/manual parking mode.

Furthermore, the surrounding information may further include a distance from an object existing around the vehicle to the vehicle, a possibility of collision, a type of the object, a parking space for the vehicle, an object for identifying the parking space (e.g., a parking line, a string, another vehicle, a wall, etc.), and the like.

The vehicle driving information is not limited to the example described above and may include all information generated from the elements provided in the vehicle.

Meanwhile, the processor 830 is configured to control one or more devices provided in the vehicle using the interface unit 820.

Specifically, the processor 830 may determine whether at least one of a plurality of preset conditions is satisfied based on vehicle driving information received through the telecommunication control unit 810. Depending on the satisfied conditions, the processor 830 may control the one or more electrical parts in different ways.

In connection with the preset condition, the processor 830 may sense the occurrence of an event in an electronic unit and/or application provided in the vehicle and determine whether the sensed event satisfies the preset condition. At this time, the processor 830 may detect the occurrence of an event from information received through the telecommunication control unit 810.

The application is a concept including a widget, a home launcher, and the like, and refers to all types of programs that can be driven on the vehicle. Accordingly, the application may be a program that performs a function of web browser, video playback, message transmission/reception, schedule management, and application update.

In addition, the application may include forward collision warning (FCW), blind spot detection (BSD), lane departure warning (LDW), pedestrian detection (PD), curve speed warning (CSW), and turn-by-turn navigation (TBT).

For example, an event may occur when there is a missed call, when there is an application to be updated, when a message arrives, start on, start off, autonomous driving on/off, LCD awake key, alarm, incoming call, missed notification, or the like.

For another example, an event may occur when a warning set by an advanced driver assistance system (ADAS) occurs or a function set by the ADAS is performed. For example, when a forward collision warning occurs, when a blind spot detection occurs, when a lane departure warning occurs, when a lane keeping assist warning occurs, when autonomous emergency braking function is performed, or the like may be seen as an occurrence of an event.

For another example, when changed from a forward gear to a reverse gear, when an acceleration greater than a predetermined value is generated, when a deceleration greater than a predetermined value is generated, when a power device is changed from an internal combustion engine to a motor, when changed from the motor to the internal combustion engine, or the like may also be seen as an occurrence of an event.

In addition, when various ECUs provided in the vehicle perform a specific function may also be seen as an occurrence of an event.

For an example, when the occurred event satisfies a preset condition, the processor 830 may control the interface unit 820 to display information corresponding to the satisfied condition on the one or more displays.

FIG. 10 is a conceptual view for explaining eHorizon associated with the present disclosure.

Referring to FIG. 10, the route provision apparatus 800 associated with the present disclosure may allow a vehicle 100 to autonomously drive on the basis of eHorizon.

eHorizon may be classified into categories such as software, a system, a concept, and the like. eHorizon denotes a configuration in which road shape information on a precision map under a connected environment such as an external server (cloud), V2X (vehicle to everything) or the like and real-time events such as real-time traffic signs, road surface conditions, accidents and the like are merged to provide relevant information to autonomous driving systems and infotainment systems.

For an example, eHorizon may refer to an external server (or cloud, cloud server).

In other words, eHorizon may perform the role of transferring a precision map road shape and real time events in front of the vehicle to autonomous driving systems and infotainment systems under an external server/V2X environment.

In order to effectively transfer eHorizon data (information) transmitted from the eHorizon (i.e., external server) to autonomous driving systems and infotainment systems, a data specification and transmission method may be formed in accordance with a standard called “ADASIS (Advanced Driver Assistance Systems Interface Specification).”

The route provision apparatus 800 associated with the present disclosure may use information received from eHorizon for autonomous driving systems and/or infotainment systems.

For example, autonomous navigation systems may be divided into safety aspects and ECO aspects.

In terms of the safety aspect, the route provision apparatus 800 according to the present disclosure may perform an ADAS (Advanced Driver Assistance System) function such as LKA (Lane Keeping Assist), TJA (Traffic Jam Assist) or the like, and/or an AD (AutoDrive) function such as advance, road joining, lane change or the like using road shape information and event information received from eHorizon and surrounding object information sensed through the sensing unit 840 provided in the vehicle.

Furthermore, in terms of the ECO aspect, the route provision apparatus 800 may receive inclination information, traffic light information, and the like on a front road from eHorizon to control the vehicle so as to achieve efficient engine output, thereby enhancing fuel efficiency.

The infotainment system may include convenience aspects.

For an example, the route provision apparatus 800 may receive accident information, road surface condition information, and the like on a front road received from eHorizon to output them on a display unit (for example, HUD (Head Up Display), CID, Cluster, etc.) provided in the vehicle to provide guide information for allowing the driver to perform safe driving.

Referring to FIG. 10, the eHorizon (external server) may receive the location information of various event information (e.g., road surface condition information 1010a, construction information 1010b, accident information 1010c, etc.) generated from a road and/or road specific speed limit information 1010d from the present vehicle 100 or other vehicles 1020a, 1020b or collect them from an infrastructure (e.g., a measuring device, a sensing device, a camera, etc.) installed on a road.

Furthermore, the event information and the road specific speed limit information may be linked to map information or may be updated.

In addition, the location information of the event information may be divided into units of lanes.

Using the information, the eHorizon (external server) of the present disclosure may provide information required for autonomous driving system and infotainment systems to each vehicle based on a precision map capable of determining a road environment (or road information) in units of lanes.

In other words, the eHorizon (external server) of the present disclosure may provide an absolute high-definition map using an absolute coordinate of information (for example, event information, location information of the present vehicle 100, etc.) associated with a road based on a precision map.

The information associated with a road provided by the eHorizon may be provided only within a predetermined region (predetermined space) with respect to the present vehicle 100.

On the other hand, the route provision apparatus 800 of the present disclosure may acquire location information of another vehicle through communication with the other vehicle. Communication with another vehicle may be carried out through V2X (vehicle to everything) communication, and data transmitted and received to and from another vehicle through V2X communication may be data in a format defined by the LDM (Local Dynamic Map) standard.

The LDM denotes a conceptual data storage located in a vehicle control unit (or ITS station) including information related to a safe and normal operation of an application (or application program) provided in a vehicle (or an intelligent transport system (ITS)). The LDM may, for example, comply with EN standards.

The LDM differs from the ADAS MAP described above in the data format and transmission method. For an example, the ADAS MAP corresponds to a high-definition map having absolute coordinates received from eHorizon (external server), and the LDM may denote a high-definition map having relative coordinates based on data transmitted and received through V2X communication.

The LDM data (or LDM information) is data that is mutually transmitted and received in V2X communication (vehicle to everything) (for example, V2V (vehicle to vehicle) communication, V2I (vehicle to infrastructure) communication, V2P (vehicle to pedestrian) communication.

The LDM is a concept of a storage for storing data transmitted and received in V2X communication, and the LDM may be formed (stored) in a vehicle control device provided in each vehicle.

The LDM data may denote, for example, data that is mutually transmitted and received between a vehicle and a vehicle (infrastructure, pedestrian) or the like. The LDM data may include, for example, a Basic Safety Message (BSM), a Cooperative Awareness Message (CAM), a Decentralized Environmental Notification Message (DENM), and the like.

The LDM data may be referred to as, for example, a V2X message or an LDM message.

The vehicle control device related to the present disclosure may efficiently manage LDM data (or V2X message) transmitted and received between vehicles efficiently using an LDM.

Based on LDM data received through V2X communication, the LDM may store all relevant information (e.g., the present vehicle (another vehicle) location, speed, traffic light status, weather information, road surface condition, etc.) on a traffic condition (or a road condition for a region within a predetermined distance from a place where a vehicle is currently located) around a place where a vehicle is currently located, and distribute them to other vehicles and continuously update them.

For an example, a V2X application provided in the route provision apparatus 800 registers with the LDM, and receives specific messages such as all DENMs including a warning about a faulty vehicle. Then, the LDM automatically allocates the received information to the V2X application, and the V2X application may control the vehicle based on information allocated from the LDM.

In this manner, the vehicle of the present disclosure may control the vehicle using an LDM formed by LDM data collected through V2X communication.

The LDM associated with the present disclosure may provide information related to a road to the vehicle control device. The information related to a road provided by the LDM provides only relative distances and relative speeds between other vehicles (or generated event points), other than map information with absolute coordinates.

In other words, the vehicle of the present disclosure may construct autonomous driving using an ADAS MAP (absolute coordinate high-definition map) according to the ADASIS standard provided by eHorizon, but the ADAS MAP may be used only to determine a road condition in a surrounding region of the present vehicle (an own vehicle).

In addition, the vehicle of the present disclosure may construct autonomous driving using an LDM (relative coordinate high-definition map) formed by LDM data received through V2X communication, but there is a limit in that accuracy is inferior due to insufficient absolute location information.

The vehicle control device included in the vehicle of the present disclosure may generate a merged precision map using the LDM data received through the VAS communication with the ADAS MAP received from eHorizon and, control the vehicle in an optimized manner using the merged precision map (autonomous driving).

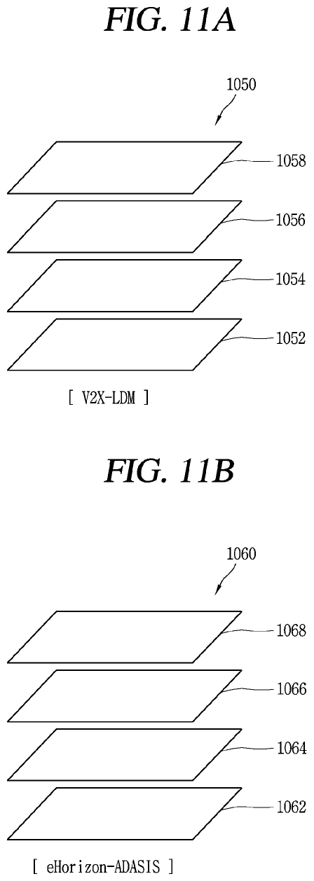

An example of a data format of the LDM data (or LDM) transmitted and received between vehicles through V2X communication is illustrated in FIG. 11A, and an example of a data format of the ADAS MAP received from an external server (eHorizon) is illustrated in FIG. 11B.

Referring to FIG. 11A, the LDM data (or LDM) 1050 may be formed to have four layers.

The LDM data 1050 may include a first layer 1052, a second layer 1054, a third layer 1056, and a fourth layer 1058.

The first layer 1052 may include static information, for example, map information, among information related to a road.

The second layer 1054 may include landmark information (e.g., specific place information specified by a maker among a plurality of place information included in the map information) among information related to the road. The landmark information may include location information, name information, size information, and the like.

The third layer 1056 may include information related a traffic environment (e.g., traffic light information, construction information, accident information, etc.) among information related to the road. The construction information, the accident information and the like may include location information.

The fourth layer 1058 may include dynamic information (e.g., object information, pedestrian information, other vehicle information, etc.) among information related to the road. The object information, pedestrian information, and other vehicle information may include location information.

In other words, the LDM data 1050 may include information sensed through the sensing unit of another vehicle or information sensed through the sensing unit of the present vehicle, and may include information related to a road that is modified in real time as it goes from a first layer to a fourth layer.

Referring to FIG. 11B, the ADAS MAP may be formed to have four layers similar to the LDM data.

The ADAS MAP 1060 may denote data received from eHorizon and formed to conform to the ADASIS standard.

The ADAS MAP 1060 may include a first layer 1062 to a fourth layer 1068.

The first layer 1062 may include topology information. The topology information, as information that explicitly defines a spatial relationship, for an example, and may refer to map information.

The second layer 1064 may include landmark information (e.g., specific place information specified by a maker among a plurality of place information included in the map information) among information related to the road. The landmark information may include location information, name information, size information, and the like.

The third layer 1066 may include high-definition map information. The high-definition map information may be referred to as an HD-MAP, and information related to the road (e.g., traffic light information, construction information, accident information) may be recorded in units of lanes. The construction information, the accident information and the like may include location information.

The fourth layer 1068 may include dynamic information (e.g., object information, pedestrian information, other vehicle information, etc.). The object information, pedestrian information, and other vehicle information may include location information.

In other words, the ADAS MAP 1060 may include information related to a road that is modified in real time as it goes from the first layer to the fourth layer, such as the LDM data 1050.

The processor 830 may autonomously drive the vehicle 100.

For example, the processor 830 may autonomously drive the vehicle 100 based on vehicle driving information sensed from various electrical parts provided in the vehicle 100 and information received through the telecommunication control unit 810.

Specifically, the processor 830 may control the telecommunication control unit 810 to acquire the location information of the vehicle. For example, the processor 830 may acquire the location information (location coordinates) of the present vehicle 100 through the location information unit 420 of the telecommunication control unit 810.

Furthermore, the processor 830 may control the first telecommunication control unit 812 of the telecommunication control unit 810 to receive map information from an external server. Here, the first telecommunication control unit 812 may receive an ADAS MAP from the external server (eHorizon). The map information may be included in the ADAS MAP.

Furthermore, the processor 830 may control the second telecommunication control unit 814 of the telecommunication control unit 810 to receive the location information of another vehicle from the other vehicle. Here, the second telecommunication control unit 814 may receive LDM data from another vehicle. The location information of the other vehicle may be included in the LDM data.

The other vehicle denotes a vehicle existing within a predetermined distance from the vehicle, and the predetermined distance may be a communication available distance of the telecommunication control unit 810 or a distance set by a user.

The processor 830 may control the communication unit to receive map information from an external server and the location information of another vehicle from the other vehicle.

In addition, the processor 830 may merge the acquired location information of the vehicle and the received location information of the other vehicle into the received map information, and control the vehicle 100 based on at least one of the merged map information and information related to the vehicle sensed through the sensing unit 840.

Here, map information received from the external server may denote high-definition map information (HD-MAP) included in an ADAS MAP. The high-definition map information may record information related to the road in units of lanes.

The processor 830 may merge the location information of the present vehicle 100 and the location information of another vehicle into the map information in units of lanes. In addition, the processor 830 may merge information related to the road received from an external server and information related to the road received from another vehicle into the map information in units of lanes.

The processor 830 may generate an ADAS MAP necessary for the control of the vehicle using the ADAS MAP received from the external server and information related to the vehicle received through the sensing unit 840.

Specifically, the processor 830 may apply information related to the vehicle sensed within a predetermined range through the sensing unit 840 to map information received from the external server.

Here, the predetermined range may be an available distance from which an electrical part provided in the present vehicle 100 senses information, or may be a distance set by a user.

The processor 830 may apply the information related to the vehicle sensed within a predetermined range through the sensing unit to the map information and then additionally merge the location information of another vehicle therewith to control the vehicle.

In other words, when the information related to the vehicle sensed within a predetermined range through the sensing unit is applied to the map information, the processor 830 may use only the information within the predetermined range from the vehicle, and thus a range capable of controlling the vehicle may be geographically narrow.

However, the location information of another vehicle received through the V2X module may be received from the other vehicle existing in a space out of the predetermined range. It is because a communication available distance of the V2X module communicating with other vehicles through the V2X module is farther than a predetermined range of the sensing unit 840.

As a result, the processor 830 may merge the location information of other vehicles included in LDM data received through the second telecommunication control unit 814 with map information on which information related to the vehicle is sensed to acquire the location information of other vehicles existing in a wider range, and more effectively control the vehicle using the merged information.

For example, it is assumed that a plurality of other vehicles are densely packed forward in a lane in which the present vehicle exists, and also assumed that the sensing unit can sense only the location information of a vehicle right in front of the present vehicle.

In this case, when only information related to the vehicle sensed within a predetermined range is used in the map information, the processor 830 may generate a control command for controlling the vehicle to allow the present vehicle to pass and overtake a vehicle in front.

However, in reality, there may be an environment in which a plurality of other vehicles are densely packed forward, and it is not easy to pass and overtake.

At this time, the present disclosure may acquire the location information of other vehicles received through the V2X module. At this time, the received location information of the other vehicles may acquire the location information of not only a vehicle right in front of the present vehicle 100 but also a plurality of other vehicles in front of the front vehicle.

The processor 830 may additionally merge the location information of a plurality of vehicles acquired through the V2X module with map information to which information related to the vehicle is applied to determine whether it is an inappropriate environment to pass and overtake a vehicle in front.

Through the foregoing configuration, the present disclosure may merge only information related to the vehicle acquired through the sensing unit 840 into high-definition map information to overcome the technical limitations of the related art that allows autonomous driving only in a predetermined range. In other words, the present disclosure may use not only information related to another vehicle received from the other vehicle at a distance greater than the predetermined range through the V2X module but also information related to the vehicle sensed through the sensing unit, thereby performing vehicle control in a more accurate and stable manner.

The vehicle control described in the present specification may include at least one of autonomously driving the vehicle 100 and outputting a warning message related to driving of the vehicle.

Hereinafter, a method of allowing the processor to control a vehicle using LDM data received through the V2X module, an ADAS MAP received from an external server (eHorizon), and information related to the vehicle sensed through the sensing unit provided in the vehicle will be described in more detail with reference to the accompanying drawings.

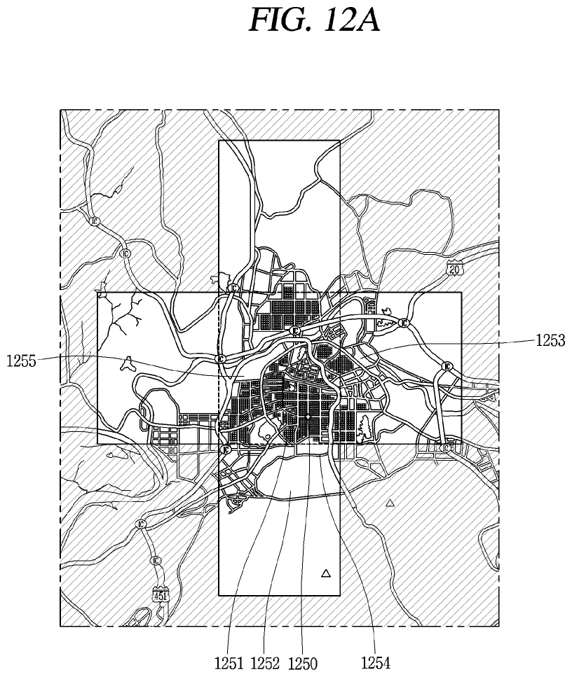

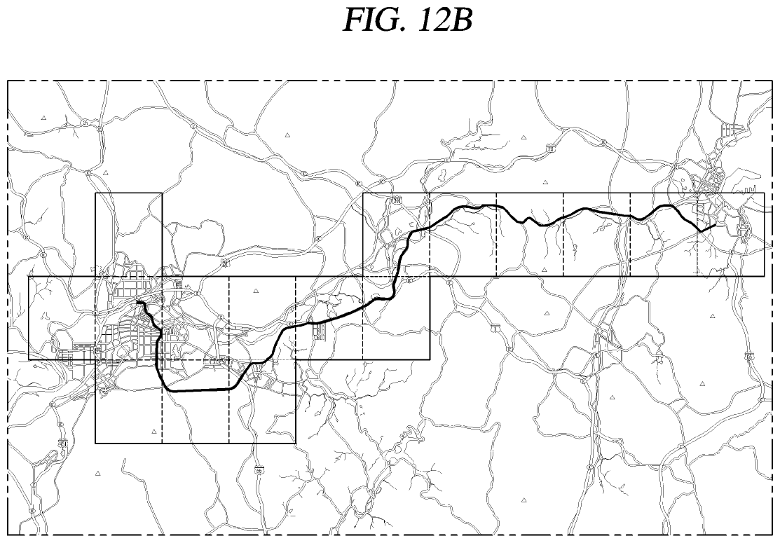

FIGS. 12A and 12B are exemplary views illustrating a method of receiving a high-definition map data by a communication device (or TCU) according to an embodiment of the present disclosure.

The server may divide HD map data into tile units and provide them to the route provision apparatus 800. The processor 830 may receive HD map data in units of tiles from a server or another vehicle through the telecommunication control unit 810. The HD map data received in units of tiles may be referred to as “HD map tiles” or “tile-based map information” in this specification.

The HD map data is partitioned into tiles having a predetermined shape, and each tile corresponds to a different part of the map. When all the tiles are connected, entire HD map data is acquired. Since the HD map data has a high capacity, a high-capacity memory is required for the vehicle 100 to download and use the entire HD map data. It is more efficient to download, use and delete HD map data in units of tiles rather than providing a high-capacity memory in the vehicle 100 with the development of communication technology.

In the present disclosure, for convenience of explanation, a case where the predetermined shape is a rectangle will be described as an example, but it may be modified into various polygonal shapes.

The processor 830 may store the downloaded HD map tiles in the memory 140. In addition, when a storage unit (or cache memory) is provided in the route provision apparatus, the processor 830 may store (or temporarily store) the downloaded HD map tile in the storage unit provided in the route provision apparatus.

The processor 830 may delete the stored HD map tiles. For example, the processor 830 may delete the HD map tiles when the vehicle 100 is moving away from a region corresponding to the HD map tiles. For example, the processor 830 may delete the HD map tiles after a preset period of time elapses subsequent to storing the HD map tiles.

As illustrated in FIG. 12A, when there is no preset destination, the processor 830 may receive a first HD map tile 1251 including the location 1250 of the vehicle 100. A server 21 may receive the location 1250 data of the vehicle 100 from the vehicle 100, and provide the first HD map tile 1251 including the location 1250 of the vehicle 100 to the vehicle 100. Furthermore, the processor 830 may receive HD map tiles 1252, 1253, 1254, 1255 around the first HD map tile 1251. For example, the processor 830 may receive the HD map tiles 1252, 1253, 1254, 1255 adjacent to the top, bottom, left, and right of the first HD map tile 1251, respectively. In this case, the processor 830 may receive a total of five HD map tiles. For example, the processor 830 may further receive a HD map tile located in a diagonal direction, along with the HD map tiles 1252, 1253, 1254, 1255 adjacent to the top, bottom, right, and left of the first HD map tile 1251, respectively. In this case, the processor 830 may receive a total of nine HD map tiles.

As illustrated in FIG. 12B, when there is a preset destination, the processor 830 may receive a tile associated with a route from the location 1250 of the vehicle 100 to the destination. The processor 830 may receive a plurality of tiles to cover the route.

The processor 830 may receive the entire tiles covering the route at once.

Alternatively, the processor 830 may divide and receive the entire tiles while the vehicle 100 is moving along the route. The processor 830 may receive at least part of the entire tiles based on the location of the vehicle 100 while the vehicle 100 is moving along the route. Then, the processor 830 may continuously receive tiles and delete the received tiles while the vehicle 100 is moving.

The processor 830 may generate electronic horizon data based on HD map data.

The vehicle 100 may be driven with the final destination being set. The final destination may be set based on a user input received through the user interface device 200 or the communication device 220. Depending on the embodiment, the final destination may be set by the driving system 260.

With the final destination being set, the vehicle 100 may be located within a preset distance a first point while driving. When the vehicle 100 is located within a preset distance from the first point, the processor 830 may generate electronic horizon data having the first point as a starting point and the second point as an end point. The first point and the second point may be one point on a route to the final destination. The first point may be described as a point at which the vehicle 100 is located or to be located in the near future. The second point may be described by the horizon mentioned above.

The processor 830 may receive a HD map in a region including a section from the first point to the second point. For example, the processor 830 may request and receive a HD map for a region within a predetermined radius from the section from the first point to the second point.

The processor 830 may generate electronic horizon data for a region including the section from the first point to the second point based on the HD map. The processor 830 may generate horizon map data for a region including the section from the first point to the second point. The processor 830 may generate horizon pass data for a region including the section from the first point to the second point. The processor 830 may generate main pass 313 data for a region including the section from the first point to the second point. The processor 830 may generate sub pass 314 data for a region including the section from the first point to the second point.

When the vehicle 100 is located within a preset distance from the first point, the processor 830 may generate electronic horizon data having the second point as a starting point and a third point as an end point. The second point and the third point may be one point on a route to the final destination. The second point may be described as a point at which the vehicle 100 is located or to be located in the near future. The third point may be described by the horizon mentioned above. On the other hand, electronic horizon data having the second point as the starting point and the third point as the end point may be geographically connected to the foregoing electronic horizon data having the first point as the starting point and the second point as the end point.

The operation of generating electronic horizon data having the second point as the starting point and the third point as the end point may be applied with the foregoing electronic horizon data having the first point as the starting point and the second point as the end point.

According to an embodiment, the vehicle 100 may be driven even when the final destination is not set.

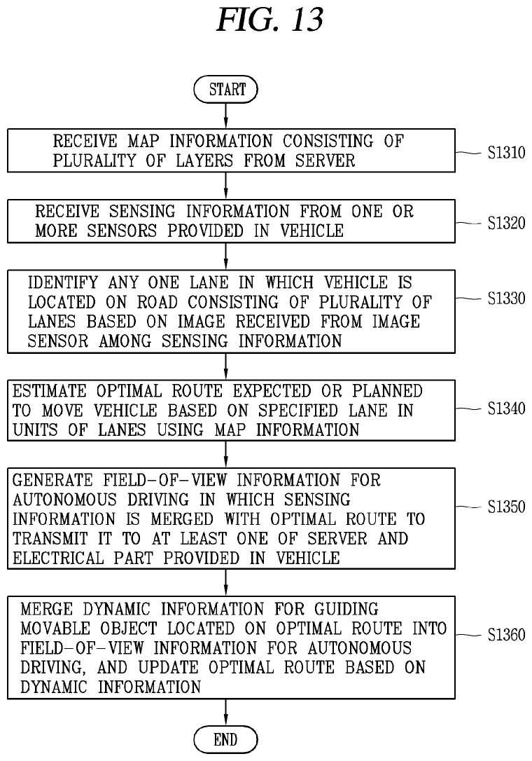

FIG. 13 is a flowchart for explaining a route provision method of the route provision apparatus of FIG. 9.

The processor 830 receives a high-definition map from an external server. Specifically, the processor 830 may receive map information (HD map, high-definition map) configured with a plurality of layers from a server (external server, cloud server) (S1310).

The external server is an example of the telematics communication device 910 as a device capable of communicating through the first telecommunication control unit 812. The high-definition map is configured with a plurality of layers. Furthermore, the high-definition map may include at least one of the four layers described above with reference to FIG. 11B as an ADAS MAP.

The map information may include horizon map data described above. The horizon map data may denote ADAS MAP (or LDM MAP) or HD MAP data formed in a plurality of layers while satisfying the ADASIS standard described with reference to FIG. 11B.

In addition, the processor 830 of the route provision apparatus may receive sensing information from one or more sensors provided in the vehicle (S1320). The sensing information may denote information sensed by each sensor (or information processed after being sensed). The sensing information may include various information according to the types of data that can be sensed by the sensor.

The processor 830 may identify any one lane in which the vehicle 100 is located on a road configured with a plurality of lanes, based on an image (or video) received from an image sensor among sensing information (S1330). Here, the lane denotes lane in which the vehicle 100 currently equipped with the route provision apparatus 800 is driving.

The processor 830 may determine a lane in which the vehicle 100 equipped with the route provision apparatus 800 is driving by using (analyzing) an image (or video) received from an image sensor (or camera) among the sensors.

In addition, the processor 830 may estimate an optimal route that is expected or planned to move the vehicle 100 based on the identified lane in units of lanes using map information (S1340). Here, the optimal route may denote the foregoing horizon pass data or main pass. However, the present disclosure is not limited thereto, and the optimal route may further include a sub route. Here, the optimal route may be referred to as a Most Preferred Path or Most Probable Path, and may be abbreviated as MPP.

In other words, the processor 830 may predict or plan an optimal route in which the vehicle 100 can travel to a destination based on a specific lane in which the vehicle 100 is driving, using map information.

The processor 830 may generate field-of-view information for autonomous driving in which sensing information is merged with an optimal route to transmit it to at least one of electrical parts provided in a server and a vehicle (S1350).

Here, the field-of-view information for autonomous driving may denote electronic horizon information (or electronic horizon data) described above. The autonomous driving horizon information, as information (or data, environment) used by the vehicle 100 to perform autonomous driving in units of lanes, may denote environmental data for autonomous driving in which all information (map information, vehicles, things, moving objects, environment, weather, etc.) within a predetermined range are merged based on a road or an optimal route including a route in which the vehicle 100 moves, as illustrated in FIG. 10. The environmental data for autonomous driving may denote data (or a comprehensive data environment), based on which the processor 830 of the vehicle 100 allows the vehicle 100 to perform autonomous driving or calculates an optimal route of the vehicle 100.

Meanwhile, the field-of-view information for autonomous driving may denote information for guiding a driving route in units of lanes. This is information in which at least one of sensing information and dynamic information is merged into an optimal route, and finally, may be information for guiding a driving route in units of lanes.

When the field-of-view information for autonomous driving refers to information for guiding a driving route in units of lanes, the processor 830 may generate different field-of-view information for autonomous driving according to whether a destination is set in the vehicle 100.

For an example, when the destination is set in the vehicle 100, the processor 830 may generate field-of-view information for autonomous driving to guide a driving route to the destination in units of lanes.

For another example, when no destination is set in the vehicle 100, the processor 830 may calculate a main route (most preferred path, MPP) having the highest possibility that the vehicle 100 may drive, and generate field-of-view for autonomous driving to guide the main route (MPP) in units of lanes. In this case, the field-of-view information for autonomous driving may further include sub route information on sub routes branched from the most preferred path (MPP) for the vehicle 100 to be movable at a higher probability than a predetermined reference.

The field-of-view information for autonomous driving may be formed to provide a driving route to the destination for each lane indicated on a road, thereby providing more precise and detailed route information. It may be route information conforming to the standard of ADASIS v3.

The processor 830 may merge dynamic information for guiding a movable object located on an optimal route to field-of-view information for autonomous driving, and update the optimal route based on the dynamic information (S1360). The dynamic information may be included in map information received from a server, and may be information included in any one (e.g., a fourth layer 1068) of a plurality of layers.

The electrical part provided in the vehicle may denote various elements provided in the vehicle, and may include, for example, sensors, lamps, and the like. The electrical part provided in the vehicle may be referred to as an eHorizon Receiver (EHR) in terms of receiving an ADASIS message including field-of-view information for autonomous driving from the processor 830.

The processor 830 of the present disclosure may be referred to as an eHorizon provider (EHP) in terms of providing (transmitting) an ADASIS Message including field-of-view information for autonomous driving.

The ADASIS message including the field-of-view information for autonomous driving may denote a message in which the field-of-view information for autonomous driving is converted in accordance with the ADASIS standard.

The foregoing description will be summarized as follows.

The processor 830 may generate field-of-view for autonomous driving to guide a road located in the front of the vehicle in units of lanes using the high-definition map (S1320).

The processor 830 receives sensing information from one or more sensors provided in the vehicle 100 through the interface unit 820. The sensing information may be vehicle driving information.

The processor 830 may identify any one lane in which the vehicle is located on a road made up of a plurality of lanes based on an image received from an image sensor among the sensing information. For example, when the vehicle 100 is driving in a first lane on an 8-lane road, the processor 830 may identify the first lane as a lane in which the vehicle 100 is located based on the image received from the image sensor.

The processor 830 may estimate an optimal route that is expected or planned to move the vehicle 100 based on the identified lane in units of lanes using the map information.

Here, the optimal route may be referred to as a Most Preferred Route or Most Probable Path, and may be abbreviated as MPP.

The vehicle 100 may drives autonomously along the optimal route. When driving manually, the vehicle 100 may provide navigation information that guides the optimal route to the driver.

The processor 830 may generate field-of-view information for autonomous driving in which the sensing information is merged into the optimal route. The field-of-view information for autonomous driving may be referred to as “eHorizon” or “electronic horizon” or “electronic horizon data” or an “ADASIS message” or a “field-of-view information tree graph.”

The processor 830 may generate different field-of-view information for autonomous driving depending on whether or not a destination is set in the vehicle 100.

For an example, when the destination is set in the vehicle 100, the processor 830 may generate an optimal route for guiding a driving route to the destination in units of lanes using field-of-view information for autonomous driving.

For another example, when a destination is not set in the vehicle 100, the processor 830 may calculate a main route in which the vehicle 100 is most likely to drive in units of lanes using field-of-view information for autonomous driving. In this case, the field-of-view information for autonomous driving may further include sub route information on sub routes branched from the most preferred path (MPP) for the vehicle 100 to be movable at a higher probability than a predetermined reference.

The field-of-view information for autonomous driving may be formed to provide a driving route to the destination for each lane indicated on a road, thereby providing more precise and detailed route information. The route information may be route information conforming to the standard of ADASIS v3.

The field-of-view information for autonomous driving may be provided by subdividing a route in which the vehicle must drive or a route in which the vehicle can drive in units of lanes. The field-of-view information for autonomous driving may include information for guiding a driving route to a destination in units of lanes. When the field-of-view information for autonomous driving is displayed on a display mounted on the vehicle 100, guide lines for guiding lanes that can be driven on a map and information within a predetermined range (e.g., roads, landmarks, other vehicles, surrounding objects, weather information, etc.) based on the vehicle may be displayed. Moreover, a graphic object indicating the location of the vehicle 100 may be included in at least one lane on which the vehicle 100 is located among a plurality of lanes included in the map.

Dynamic information for guiding a movable object located on the optimal route may be merged into the field-of-view information for autonomous driving. The dynamic information may be received at the processor 830 through the telecommunication control unit 810 and/or the interface unit 820, and the processor 830 may update the optimal route based on the dynamic information. As the optimal route is updated, the field-of-view information for autonomous driving is also updated.

The dynamic information may be referred to as dynamic information, and may include dynamic data.

The processor 830 may provide the field-of-view information for autonomous driving to at least one electrical part provided in the vehicle. Moreover, the processor 830 may provide the field-of-view information for autonomous driving to various applications installed in the system of the vehicle 100.

The electrical part may denote any communicable device mounted on the vehicle 100, and may include the elements described above with reference to FIGS. 1 through 9 (e.g., the components 120-700 described above with reference to FIG. 7). For example, an object detecting apparatus 300 such as a radar and a lidar, a navigation system 770, a vehicle operating apparatus 600, and the like may be included in the electrical part.

In addition, the electrical part may further include an application executable in the processor 830 or a module that executes the application.

The electrical part may perform its own function to be carried out based on the field-of-view information for autonomous driving.

The field-of-view information for autonomous driving may include a lane-base route and a location of the vehicle 100, and may include dynamic information including at least one object that must be sensed by the electrical part. The electrical part may reallocate a resource to sense an object corresponding to the dynamic information, determine whether the dynamic information matches sensing information sensed by itself, or change a setting value for generating sensing information.

The field-of-view information for autonomous driving may include a plurality of layers, and the processor 830 may selectively transmit at least one of the layers according to an electrical part that receives the field-of-view information for autonomous driving.

Specifically, the processor 830 may select at least one of a plurality of layers included in the field-of-view information for autonomous driving, based on at least one of a function being executed by the electrical part and a function scheduled to be executed. In addition, the processor 830 may transmit the selected layer to the electronic part, but the unselected layer may not be transmitted to the electrical part.

The processor 830 may receive external information generated by an external device from the external device located within a predetermined range with respect to the vehicle.

The predetermined range is a distance at which the second telecommunication control unit 914 can perform communication, and may vary according to the performance of the second telecommunication control unit 914. When the second telecommunication control unit 914 performs V2X communication, a V2X communication range may be defined as the predetermined range.

Moreover, the predetermined range may vary according to an absolute speed of the vehicle 100 and/or a relative speed with respect to the external device.

The processor 830 may determine the predetermined range based on the absolute speed of the vehicle 100 and/or the relative speed with respect to the external device, and allow communication with an external device located within the determined predetermined range.

Specifically, external devices capable of communicating through the second telecommunication control unit 914 may be classified into a first group or a second group based on the absolute speed of the vehicle 100 and/or the relative speed with respect to the external device. External information received from an external device included in the first group is used to generate dynamic information described below, but external information received from an external device included in the second group is not used to generate the dynamic information. Even when external information is received from an external device included in the second group, the processor 830 ignores the external information.

The processor 830 may generate dynamic information of an object that must be sensed by at least one electrical part provided in the vehicle based on the external information, and may match the dynamic information to the field-of-view information for autonomous driving.

For an example, the dynamic information may correspond to the fourth layer described above with reference to FIGS. 11A and 11B.

As described above in FIGS. 11A and 11B, the route provision apparatus 800 may receive ADAS MAP and/or LDM data. Specifically, the ADAS MAP may be received from the telematics communication device 910 through the first telecommunication control unit 812 and the LDM data may be received from the V2X communication device 920 through the second telecommunication control unit 814.

The ADAS MAP and the LDM data may be configured with a plurality of layers having the same format. The processor 830 may select at least one layer from the ADAS MAP, select at least one layer from the LDM data, and generate the field-of-view information for autonomous driving configured with the selected layers.

For example, the processor 830 may select the first to third layers of the ADAS MAP, select the fourth layer of the LDM data, and generate one field-of-view information for autonomous driving in which four layers are combined into one. In this case, the processor 830 may transmit a reject message for rejecting the transmission of the fourth layer to the telematics communication device 910. It is because the first telecommunication control unit 812 uses less resources to receive some information excluding the fourth layer than to receive all the information including the fourth layer. Part of the ADAS MAP may be combined with part of the LDM data to use mutually complementary information.

For another example, the processor 830 may select the first to fourth layers of the ADAS MAP, select the fourth layer of the LDM data, and generate one field-of-view information for autonomous driving in which five layers are combined into one. In this case, priority may be given to the fourth layer of the LDM data. When there is discrepancy information that does not match the fourth layer of the LDM data in the fourth layer of the ADAS MAP, the processor 830 may delete the discrepancy information or correct the discrepancy information based on the LDM data.

The dynamic information may be object information for guiding a predetermined object. For example, at least one of a location coordinate for guiding the location of the predetermined object, and information for guiding the shape, size, and type of the predetermined object may be included in the dynamic information.

The predetermined object may denote an object that obstructs driving in the corresponding lane among objects that can drive on a road.

For example, the predetermined object may include a bus stopping at a bus stop, a taxi stopping at a taxi stop, a truck dropping a courier, and the like.

For another example, the predetermined object may include a garbage collection vehicle driving at a constant speed or below, or a large vehicle (e.g., truck or container truck, etc.) determined to obstruct view.

For still another example, the predetermined object may include an object indicating an accident, road damage, or construction.

As described above, the predetermined object may include all types of objects disallowing the driving of the present vehicle 100 or obstructing the lane not to allow the vehicle 100 to drive. Traffic signals such as ice roads, pedestrians, other vehicles, construction signs, and traffic lights to be avoided by the vehicle 100 may correspond to the predetermined object and may be received by the route provision apparatus 800 as the external information.

Meanwhile, the processor 830 may determine whether a predetermined object guided by the external information is located within a reference range based on the driving route of the vehicle 100.

Whether or not the predetermined object is located within the reference range may vary depending on the lane on which the vehicle 100 drives and the location of the predetermined object.

For example, external information for guiding a sign indicating the construction of a third lane ahead 1 km while driving on a first lane may be received. When the reference range is set to 1 m with respect to the vehicle 100, the sign is located out of the reference range. It is because when the vehicle 100 continues to drive on the first lane, the third lane is located out of 1 m with respect to the vehicle 100. On the contrary, when the reference range is set to 10 m with respect to the vehicle 100, the sign is located within the reference range.

The processor 830 generates the dynamic information based on the external information when the predetermined object is located within the reference range, but does not generate the dynamic information when the predetermined object is located out of the reference range. In other words, the dynamic information may be generated only when the predetermined object guided by the external information is located on a driving route of the vehicle 100 or within a reference range capable of affecting the driving route of the vehicle 100.

Since the route provision apparatus according to the present disclosure combines information received through the first telecommunication control unit and information received through the second telecommunication control unit into one information during the generation of field-of-view information for autonomous driving, optimal field-of-view information for autonomous driving in which information provided through different telecommunication control units are mutually complemented. It is because the information received through the first telecommunication control unit has a restriction in that it is unable to reflect the information in real time, but the information received through the second telecommunication control unit complements the real-time property.

Further, since when there is information received through the second telecommunication control unit, the processor 830 controls the first telecommunication control unit so as not to receive the corresponding information, it may be possible to use the bandwidth of the first telecommunication control unit less than the related art. In other words, the resource use of the first telecommunication control unit may be minimized.

Hereinafter, the processor 830 capable of performing a function/operation/control method of eHorizon as described above will be described in more detail with reference to the accompanying drawings.

FIG. 14 is a conceptual view for explaining a processor included in a route provision apparatus according to the present disclosure.

As described above, the route provision apparatus 800 of the present disclosure may provide a route to a vehicle, and may include the telecommunication control unit 810, the interface unit 820, and the processor 830 (EHP).

The telecommunication control unit 810 may receive map information configured with a plurality of layers from a server. At this time, the processor 830 may receive map information (HD map tiles) formed in units of tiles through the telecommunication control unit 810.

The interface unit 820 may receive sensing information from one or more sensors provided in the vehicle.

The processor 830 may include (have) eHorizon software described herein. As a result, the route provision apparatus 830 may be an EHP (Electronic Horizon Provider).

The processor 830 may identify any one lane in which the vehicle is located on a road configured with a plurality of lanes based on an image received from an image sensor among the sensing information.

Furthermore, the processor 830 may estimate an optimal route that is expected or planned to move the vehicle 100 based on the identified lane in units of lanes using the map information.

The processor 830 may generate field-of-view information for autonomous driving in which sensing information is merged with the optimal route to transmit it to at least one of electrical parts provided in the server and the vehicle.

Since the field-of-view information for autonomous driving merged with the optimal route and sensing information is based on an HD map, it may be configured with a plurality of layers, and the description of FIGS. 11A and 11B will be analogically applied to each layer in the same or similar manner.

Dynamic information for guiding a movable object located on the optimal route may be merged into the field-of-view information for autonomous driving.

The processor 830 may update the optimal route based on the dynamic information.

The processor 830 may include a map cacher 831, a map matcher 832, map-dependent APIs (MAL) 833, a route generator 834, a horizon generator 835, an ADASIS generator 836, and a transmitter 837.

The map cacher 831 may store and update map information (HD map data, HD map tiles, etc.) received from the server (cloud server, external server) 1400.

The map matcher 832 may map a current location of the vehicle to the map information.

The map-dependent API (MAL) 833 may convert map information received from the map cacher 831 and information that maps the current location of the vehicle to the map information in the map matcher 832 into a data format that can be used by the horizon generator 835.

Furthermore, the map-dependent API (MAL) 833 may transfer or operate an algorithm to transfer map information received from the map cacher 831 and information that maps the current location of the vehicle to the map information in the map matcher 832 to the horizon generator 835.

The route generator 834 may provide road information on which the vehicle can drive from the map information. In addition, the route generator 834 may receive road information that can be driven from AVN, and provide information required for generating a route (optimal route or sub route) on which the vehicle can drive to the horizon generator 835.

The horizon generator 835 may generate a plurality of route information that can be driven based on the current location of the vehicle and the road information that can be driven.

The ADASIS generator 836 may convert the plurality of route information generated by the horizon generator 835 into a message form to generate an ADASIS message.

In addition, the transmitter 837 may transmit the ADASIS message generated in the form of a message to an electrical part provided in the vehicle.

Hereinafter, each element will be described in more detail.

The map cacher 831 may request tile-based map information (HD map tiles required for the vehicle) among a plurality of tile-based map information (a plurality of HD map tiles) existing in the server 1400.

Furthermore, the map cacher 831 may store (or temporarily store) tile-based map information (HD map tiles) received from the server 1400.

The map cacher 831 may include an update management module 831b (update manager) that requests and receives at least one map information among the plurality of tile-based map information existing in the server 1400 based on a preset condition being satisfied and a cache memory 831a (map caching) that stores the tile-based map information received from the server 1400.

The cache memory 831a may also be referred to as a tile map storage.

The preset condition may denote a condition for requesting and receiving tile-based map information required for the vehicle from the route provision apparatus (specifically, the map cacher 831) to the server 1400.

The preset condition may include at least one of a case where update for tile-based map information is required in a region where the vehicle is currently present, a case where tile-based map information in a specific zone is requested from an external device, and a case where its tile unit size is changed.

For example, the map cacher 831 included in the processor 830 may request and receive tile-based map information in which the vehicle is currently located, tile-based map information in a specific zone requested from an external device or tile-based map information whose tile unit size is changed to and from the server based on the preset condition being satisfied.

When new tile-based map information is received from the server 1400, the update management module 831b may delete the existing map information in a zone indicated by (included in) the received map information and tile-based map information for a region in which has passed by driving the vehicle from the cache memory 831a.

The map matcher 832 may include a position providing module 832a (position provider) that extracts data indicating the current location of the vehicle from any one of a signal received from a satellite (GNSS (Global Navigation Satellite System) signal (e.g., a signal indicating the current location of the vehicle received from a satellite)), a driving history, and a component provided in the vehicle, a filter 832b (Kalman filter) that filters the data extracted from the position provider to generate location information indicating the current location of the vehicle), and a map matching module 832c (MM) that maps location information indicating the current location of the vehicle onto tile-based map information stored in the map cacher, and performs position control so that the current location of the vehicle is located at the center of the display module.

Here, performing position control so that the current location of the vehicle is located at the center of the display module may include the meaning of mapping map information received through the server 1400 based on the current location of the vehicle.

The map matching module 832c may request the map cacher 831 to receive tile-based map information for mapping the location information from the server when the tile-based map information for mapping the location information does not exist in the map cacher 831.

In this case, the map cacher 831 may request and receive the tile-based map information (HD map tiles) requested from the map matching module 832c to the server 1400 in response to the request to transmit the map information to the map matcher (or map matching module 832c).

In addition, the map matching module 832c may generate location information indicating the current location of the vehicle with a position command 832d and transmit it to the horizon generator 835. The position command may be used to generate horizon information based on the current location of the vehicle when the horizon information is generated by the horizon generator.

The map-dependent API (MAL) 833 may convert map information (tile-based map information, HD map tiles) received from the map cacher 831 and information that maps the current location of the vehicle to the map information in the map matcher 832 into a data format that can be used by the horizon generator 835.

The route generator 834 may extract road information on which the vehicle can drive from the received tile-based map information (HD map tiles), and provide road information extracted to calculate an optimal route and a sub route expected to be driven by the vehicle to the horizon generator.

In other words, the received map information may include various types of roads, for example, a roadway through which vehicles can pass, a road through which vehicles cannot pass (e.g., a pedestrian road, a bicycle road, and a narrow road).

The route generator 834 may extract road information on which a vehicle can drive among various types of roads included in the map information. At this time, the road information may also include direction information for a one-way road.

Specifically, the route generator 834 may include a road management module 834a (route manager) that assigns a score to route information required for driving from a current location of the vehicle to a destination among road information that can be driven, from tile-based map information (HD map tiles) received from the server 1400, a custom logic module 834b (custom logic) that assigns a score to a road after its next intersection according to the characteristics of the road where the vehicle is currently located, and a crossing callback module 834c (crossing callback (CB)) that provides information reflecting the score assigned by the road management module 834a and the score assigned by the custom logic module 834b to the horizon generator 835.

The crossing callback module 834c may perform route guidance based on the score assigned by the road management module 834a (or transmit road information to which the score is assigned by the road management module to the horizon generator) when the vehicle is located on a route corresponding to route information required to drive to the destination, and perform route guidance based on the score assigned by the custom logic module (or transmit road information to which the score is assigned by the custom logic module to the horizon generator) when the vehicle deviates from a route corresponding to route information required to drive to the destination.

This is to allow the horizon generator 845 to generate an optimal route and field-of-view information for autonomous driving required to drive to a destination based on the road information to which the score is assigned by the road management module when the destination is set.

Furthermore, when a destination is not set or when the vehicle deviates from a route corresponding to route information required to drive to the destination, the horizon generator 835 may generate an optimal route or sub route based on a road to which the score is assigned by the custom logic module 834b, and generate field-of-view information for autonomous driving corresponding to the optimal route and the sub route.

The horizon generator 835 may generate a horizon tree graph with respect to a current location of the vehicle, based on the location of the vehicle mapped to map information by the map matcher 832 and road information that can be driven, processed by the route manager.

Here, the horizontal tree graph may denote information in which roads generated with field-of-information for autonomous driving are connected to the optimal route and sub route at each interconnection (or each portion separated from a road) from the current location of the vehicle to the destination.

Such information may be referred to as a horizontal tree graph since it is seen as a tree branch shape by connecting roads generated with field-of-view information for autonomous driving at an intersection.

In addition, field-of-view information for autonomous driving is generated not only for a single route (optimal route) but also for a plurality of routes (an optimal route and a plurality of sub routes) since the field-of-view for autonomous driving is not generated only for an optimal route from the current location of the vehicle to the destination but also for sub routes different from the optimal route (roads corresponding to sub routes other than a road corresponding to the optimal route at an intersection).

Accordingly, the field-of-view information for autonomous driving from the current location of the vehicle to the destination may have a shape in which branches of a tree extend, and accordingly, the field-of-view information for autonomous driving may be referred to as a horizontal tree graph.

The horizon generator 835 (or horizontal generation module 835a) may set a length of a horizontal tree graph 835b and a width of a tree link, and generate the horizontal tree graph with respect to roads within a predetermined range from a road on which the vehicle is currently located, based on the current location of the vehicle and the tile-based map information.

Here, the width of the tree link may denote a width that generates field-of-view information for autonomous driving (e.g., a width allowed to generate field-of-view information for a sub route only up to a predetermined width (or radius) based on an optimal route).

In addition, the horizon generator 835 may connect roads included in the generated horizontal tree graph in units of lanes.

As described above, the field-of-view information for autonomous driving may calculate an optimal route, sense an event, sense vehicle traffic, or determine dynamic information in units of lanes included in a road, other than in units of roads.

Accordingly, the horizontal generator 835 may generate a horizontal tree graph by connecting roads included in the generated horizontal tree graph in units of lanes included in the roads, instead of simply connecting roads to roads included in the generated horizontal tree graph.

Furthermore, the horizon generator 835 may generate different horizontal tree graphs according to a preset generation criterion.

For example, the horizontal generator 835 may generate a different optimal route and sub route based on a user input (or a user request), or based on a criterion for generating the optimal route and sub route (e.g., the fastest route to reach the destination, the shortest route, a free route, a high-speed road priority route, etc.), and accordingly, generate different field-of-view information for autonomous driving.

Since differently generating field-of-view information for autonomous driving may denote generating field-of-view information for autonomous driving for a different road, and thus field-of-view information for autonomous driving generated on a different road may eventually denote generating a different horizontal tree graph.

The horizon generator 835 may generate an optimal route and a sub route on which the vehicle is expected to drive based on road information that can be driven, transmitted from the route generator 834.

In addition, the horizon generator may generate or update the optimal route and sub route by merging dynamic information with field-of-view information for autonomous driving.

The ADASIS generator 836 may convert a horizontal tree graph generated by the horizon generator 835 into an ADASIS message to have a predetermined message form.

As described above, in order to effectively transmit eHorizon (electronic Horizon) data to autonomous driving systems and infotainment systems, the EU OEM (European Union Original Equipment Manufacturing) Association has established a data specification and transmission method as a standard under the name “ADASIS (ADAS (Advanced Driver Assist System) Interface Specification).”

Accordingly, the EHP (the processor 830 of the route provision apparatus) of the present disclosure may include an ADASIS generator 836 that converts a horizontal tree graph (i.e., field-of-view information for autonomous driving or an optimal route and a sub route) into a predetermined message form (e.g., a message form in a format conforming to the standard).

The ADASIS message may correspond to the field-of-view information for autonomous driving. In other words, since a horizontal tree graph corresponding to field-of-view information for autonomous driving is converted into a message form, the ADASIS message may correspond to the field-of-view information for autonomous driving.

The transmitter 837 (transmitter) may include a message queue module 837a that transmits an ADASIS message to at least one of electrical parts provided in the vehicle.

The message queue module 837a may transmit the ADASIS message to the at least one of electrical parts provided in the vehicle in a preset scheme (Tx).

Here, the preset scheme may transmit ADASIS messages with a function (Tx) of transmitting messages or a condition of transmitting messages in the order in which the ADASIS messages were generated, first transmit a specific message based on the message content, or preferentially transmit a message requested from an electrical part provided in the vehicle.

The lane unit described above may refer to a drive way (lane) unit set on a road for a vehicle to drive. In the present specification, a lane set for a vehicle to drive on a road may be used interchangeably as a drive way or a lane.

Meanwhile, the route provision apparatus according to an embodiment of the present disclosure may interact with a rollable display provided in a vehicle.

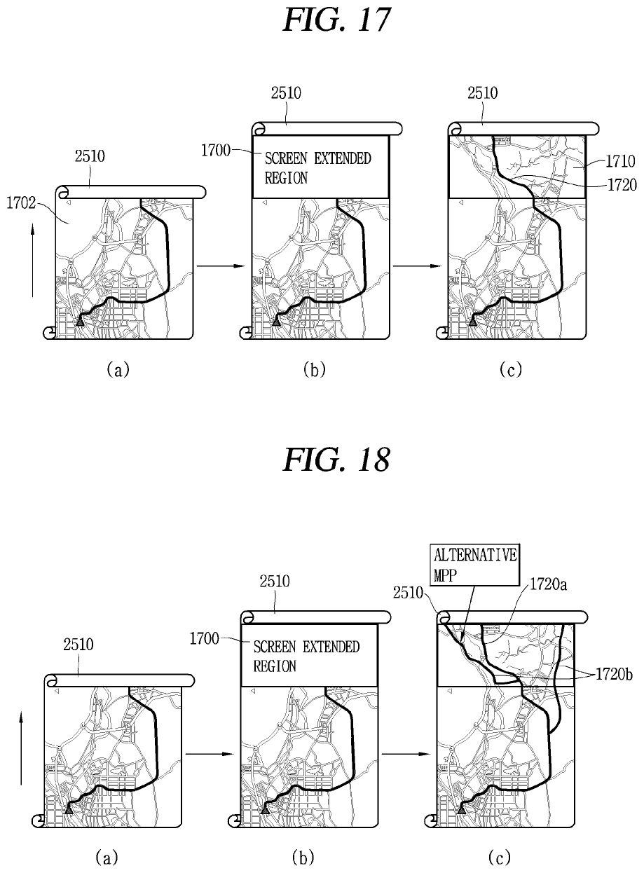

Hereinafter, an embodiment in which the route provision apparatus 800 interacts with a rollable display when a vehicle is provided with a rollable (or bendable) display 2510 (see FIG. 17) will be described in more detail.

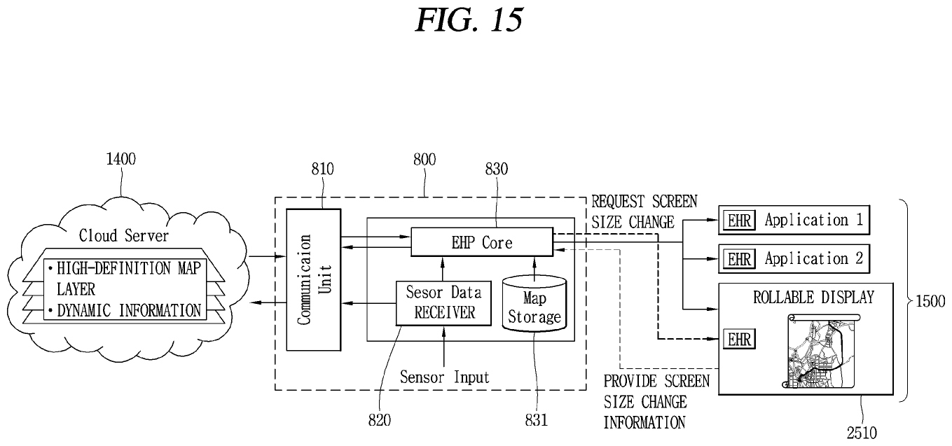

FIG. 15 is a conceptual view for explaining the concept of a route provision apparatus and a rollable display of the present disclosure.

Referring to FIG. 15, the route provision apparatus 800 of the present disclosure may communicate with the server 1400 through the telecommunication control unit 810.

For example, the processor 830 may receive map information configured with a plurality of layers from the server 1400 through the telecommunication control unit 810.

The processor 830 may store (or temporarily store) the received map information in the memory (map storage) 831.

Furthermore, the processor 830 may receive sensing information sensed from a sensor included in the vehicle through the interface unit 820.

In addition, the processor 830 may transmit at least one of field-of-view information for autonomous driving and a lane-based optimal route to at least one component 1410 provided in the vehicle. Here, at least one component 1410 provided in the vehicle may include the elements described in FIG. 7.

Meanwhile, the rollable display 2510 may be provided (mounted) in the vehicle 100 of the present disclosure.

The rollable display may be included in at least one component 1410 provided in the vehicle.

The rollable display may be included in the above-described display module 251, and may be understood as one of various implementation methods of the display module 251.

The rollable display may refer to a display device implemented through a display panel implemented through flexible OLED technology.

The rollable display is a display device that can be rolled in the form of a roll, and may be referred to as a rollable display or a scroll display.

Since the rollable display can be rolled into a scroll, there is a product capable of displaying a screen with a larger area than the device itself.

In other words, the rollable display may be stored in a much smaller volume than a displayed screen area thereof, and provided in various locations such as a portion of a dashboard, a cluster, an A-pillar, and an upper end of windshield in the vehicle, and may be enlarged (its rolled portion being stretched) or reduced (its stretched portion being rolled) by a user request or the control of the vehicle/route provision apparatus.

The processor 830 of the route provision apparatus 800 may perform interaction (data transmission/reception, communication) with the rollable display 2510 provided in the vehicle.

For example, as illustrated in FIG. 15, when a screen size (display region size) of the rollable display 2510 is changed by external manipulation, the processor 830 may receive screen size change information from the rollable display 2510.

For another example, when entering an environment in which a screen size of the rollable display 2510 needs to be changed, the processor 830 may request (control) the rollable display 2510 to change the screen size.

Hereinafter, a control method of a route provision apparatus capable of providing field-of-view information for autonomous driving or a lane-based optimal route by interacting with a rollable display provided in a vehicle will be described in more detail.

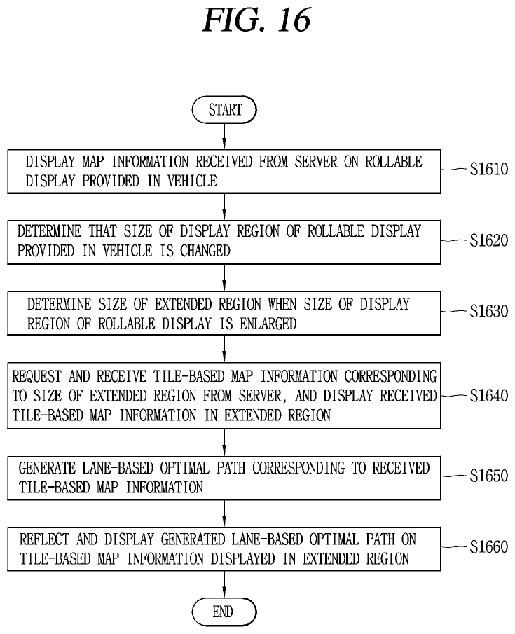

FIG. 16 is a flowchart for explaining a representative control method of the present disclosure, and FIGS. 17, 18, 19, 20, 21 and 22 are conceptual views for explaining a control method illustrated in FIG. 16.

First, referring to FIG. 16, the processor 830 of the route provision apparatus 800 of the present disclosure may output map information received from a server to a rollable display 2510 provided in the vehicle (S1610).

Meanwhile, the processor 830 may determine that a size of a display region of the rollable display provided in the vehicle is changed (S1620).

For example, in the rollable display 2510, a size of the display region may be varied by an external force applied by a user, or a size of the display region of the rollable display may be changed based on the operation of a button configured to unroll or roll the rollable display 2510.

Here, varying the size of the display region may be performed based on the rollable display being rolled or its rolled portion being unrolled (or stretched).

In this manner, varying the size of the display region of the rollable display may be carried out by a user directly pulling or rolling the rollable display (or pulling lightly and then releasing it to roll, such as a blind), or may be performed based on a user operating a button (manipulation button) implemented to roll or unroll the rollable display, such as a window of the vehicle.

When a size of the display region of the rollable display 2510 is varied, the processor 830 may receive information related to the changed size of the display region (screen size change information) from the rollable display 2510.

Based on the size of the changed display region, the processor 830 may request and receive map information to be displayed on the changed display region from the server.

Specifically, when the size of the display region of the rollable display is enlarged, the processor 830 may determine the size of the extended (enlarged) region (S1630). As described above, when the size of the display region of the rollable display is changed by an external force (or user manipulation), the rollable display may transmit information related to the changed display region (i.e., screen size change information) to the route provision apparatus.

In this case, the processor 830 may determine the size of the changed region based on the received information related to the changed display region (screen size change information).

That is, when the size of the display region of the rollable display is enlarged, the processor 830 may determine the size of the extended region based on the screen size change information.

The processor 830 may request and receive tile-based map information corresponding to the size of the extended region from the server 1400, and output the received tile-based map information to the extended region (S1640).

Furthermore, the processor 830 may generate a lane-based optimal route corresponding to the received tile-based map information (S1650).

That is, when tile-based map information according an enlarged size of the display region of the rollable display is received from the server 1400, the processor 830 may newly generate a lane-based optimal route, which is expected or planned to drive the vehicle, on the received tile-based map information.

Then, the processor 830 may reflect and display the generated lane-based optimal route on tile-based map information displayed in the extended region (S1660).

The processor 830 may control the rollable display of the vehicle to reflect and display the generated lane-based optimal route on the tile-based map information displayed in the extended region.

That is, when the display region of the rollable display is varied, the processor 830 may enlarge or reduce map information to fit the varied display region, and may additionally receive map information from the server when the display region is enlarged.

In addition, the processor 830 may newly generate an optimal route with respect to the received map information, and display the newly generated optimal route on the rollable display 2510 by reflecting it to the additionally received map information.

Referring to (a) of FIG. 17, the processor 830 may display map information 1702 received from the server on the rollable display 2510 provided in the vehicle.

At this time, as illustrated in (b) of FIG. 17, the display region of the rollable display 2510 may be enlarged by a user manipulation. In this case, the rollable display 2510 may provide information on an enlarged region 1710 (i.e., screen size change information) to the route provision apparatus 800.

The processor 830 may determine a size of the enlarged region 1710 based on information on the enlarged region received from the rollable display 2510.

Then, as illustrated in (c) of FIG. 17, the processor 830 may requests and receive tile-based map information 1710 corresponding to the size of the extended region from the server, and display the received tile-based map information in the extended region 1700.

In addition, the processor 830 may generate a lane-based optimal route 1720 corresponding to the map information 1710 displayed in the extended region 1700, and reflect and display the generated optimal route 1720 on the map information 1710.

The tile-based map information requested from the server 1400 may be map information in one tile unit processed to correspond to a size of the enlarged region, or map information in units of a plurality of tiles having a predetermined size (i.e., a size smaller than the size of the enlarged region) so as to be all displayed in the enlarged region.

Meanwhile, when tile-based map information to be displayed in the changed display region is previously stored in the memory 831, the processor 830 may extract tile-based map information to be displayed in the changed display region in the memory 831.

Then, the processor 830 may display the extracted tile-based map information in the changed display region (i.e., the enlarged region 1700) of the rollable display.

Meanwhile, as illustrated in (a) and (b) of FIG. 18, when the size of the display region of the rollable display 2510 is enlarged, the processor 830 may receive map information corresponding to the size of the extended region 1700 from the server to display the received map information.

At this time, as illustrated in (c) of FIG. 18, the processor 830 may generate a new lane-based optimal route 1720b that can be driven from the map information 1710 displayed in the extended region, and display the new optimal route 1720b on the map information 1710 displayed in the extended region 1700.

Here, the new optimal route may include at least one of extended route information 1720a of an optimal route that has been previously displayed prior to enlarging the rollable display, and auxiliary route information (or alternative optimal route) 1720b calculated based on the map information displayed in the enlarged region.

That is, when new map information is displayed in the enlarged region, the processor 830 may calculate a plurality of optimal routes, and reflect the plurality of the calculated optimal routes on map information that has been previously displayed and map information displayed in the enlarged region.

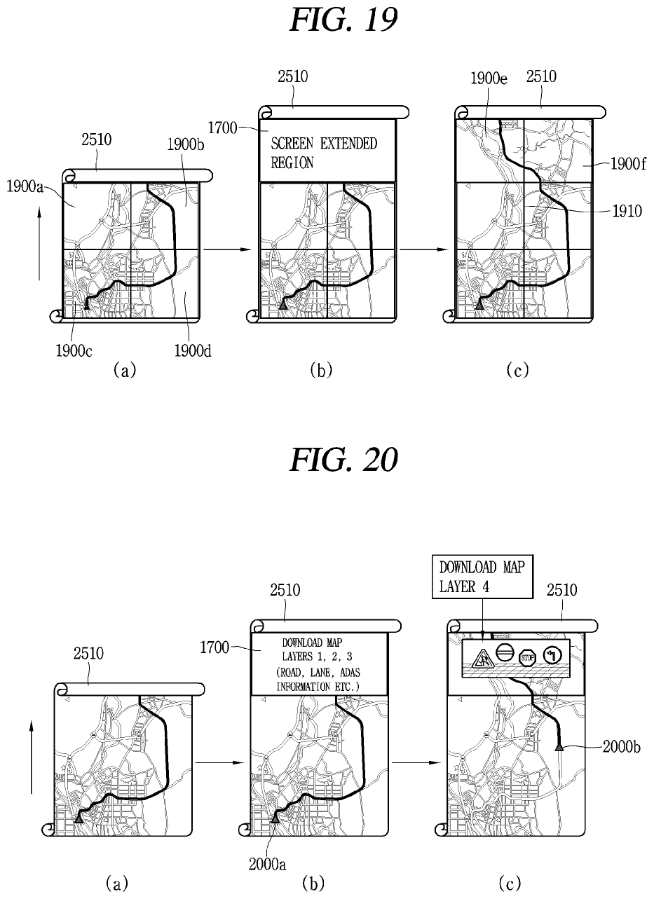

Meanwhile, before the size of the display region of the rollable display is changed, as illustrated in (a) of FIG. 19, the processor 830 may receive map information in units of a first number of tiles (e.g., four 1900a, 1900b, 1900c, 1900d) from the server and display the received map information on the rollable display 2510.

Then, as illustrated in (b) of FIG. 19, when the display region of the rollable display is enlarged, the processor 830 may receive map information in units of a second number of tiles (e.g., six 1900a, 1900b, 1900c, 1900d, 1900e, 1900f) greater than the first number of tiles from the server and display the received map information on the rollable display 2510 so as to display the map information in the extended region 1700.

That is, since map information needs to be displayed in a larger region (space) when the display region of the rollable display is enlarged, the processor 830 may receive map information in units of a larger number of tiles than that of map information that has been previously displayed and display the received map information on the enlarged rollable display.

At this time, as illustrated in (c) of FIG. 19, the processor 830 may display a graphic object (e.g., a dividing line, etc.) 1910 that divides tile-based map information on the rollable display 2510 so as to identify the tile-based map information.

Through this, the present disclosure may identify how many units of tiles of map information are displayed on the rollable display, and provide a user interface capable of inferring the amount of data consumed accordingly.

Meanwhile, as illustrated in (a) and (b) of FIG. 20, when the display region of the rollable display is enlarged, the processor 830 may receive only some layers among a plurality of layers constituting map information to be displayed in the extended region 1700 from the server, and display the received some layers in the extended region.

For example, the some layers that are preferentially displayed in the extended region among the plurality of layers may be the first to third layers (excluding the fourth layer) described above.

That is, the processor 830 may preferentially receive only the first to third layers including road information, lane information, and ADAS information from the server and display them in the extended region.

Then, as illustrated in (c) of FIG. 20, when the vehicle enters within a predetermined distance from a place corresponding to a predetermined point of map information displayed in the extended region 1700 (e.g., a point where a previously generated optimal route meets the extended region), the processor 830 may receive the remaining layer (the fourth layer) except for the some layers (the first to third layers) among the plurality of layers from the server to reflect the received remaining layers on the map information displayed in the extended region 1700.

The fourth layer may be a dynamic layer including dynamic information reflecting real-time events.

That is, when receiving map information corresponding to the extended region from the server, the processor 830 may receive and output only some layers (the first to third layers) capable of calculating map information and an optimal route, except for the fourth layer including dynamic information that changes in real time, in case a where a distance between the vehicle and the place corresponding to the map information of the extended region is long.

Then, when the vehicle approaches a place corresponding to the map information displayed in the extended region, a layer including dynamic information that changes in real time may be received from the server and reflected in the map information displayed in the extended region.

Through this configuration, the route provision apparatus of the present disclosure may preferentially receive only some layers of map information consisting of a plurality of layers from the server to quickly generate and display map information and route information (an optimal route) in the extended region so as to provide a control method capable of minimizing unnecessary data consumption.

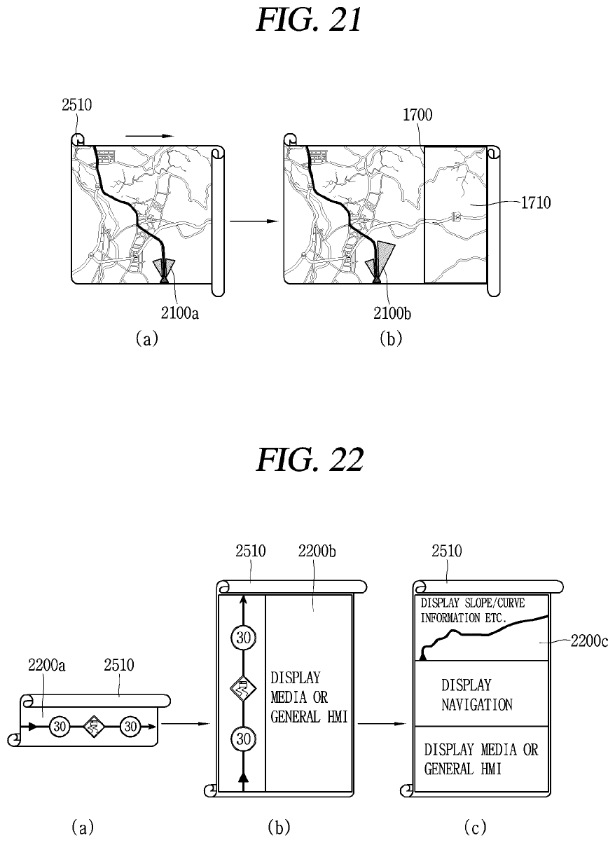

Meanwhile, as illustrated in (a) of FIG. 21, the processor 830 may display new map information in the extended region as the display region of the rollable display is enlarged. At this time, an object 2100a indicating a sensing range of a sensor that senses information on an object corresponding to the present vehicle may be displayed on the rollable display.

As illustrated in (b) of FIG. 21, when the display region of the rollable display is extended, the processor 830 may extend a sensing range of the sensor of the vehicle that senses information in a direction (right) corresponding to a direction (e.g., right) in which new map information is displayed.

In addition, as illustrated in (b) of FIG. 21, when the sensing range of the sensor of the vehicle is extended, the processor 830 may display an object 2100b indicating the extended sensing range and information indicating the type of sensor with the extended sensing range (not shown) on the rollable display 2510.

Meanwhile, the processor 830 may display at least one of map information and an optimal route on the rollable display in a different manner based on a size of the display region of the rollable display 2510.

For example, as illustrated in (a) of FIG. 22, when the size of the display region of the rollable display 2510 is a first size, the processor 830 may display only information 2200a corresponding to the optimal route on the rollable display.

The information 2200a corresponding to the optimal route may include information set to be provided to the user for each section (e.g., speed limit, curve warning, etc.).

On the contrary, when the rollable display 2510 is extended by a user manipulation, the processor 830 may display a first type of screen interface 2200b including media information, human machine interface (HMI) information (generally displayed navigation information), map information or field-of-view information for autonomous driving in addition to information corresponding to the optimal route based on the size of the display region of the display 2510, which is a second size larger than the first size.

On the other hand, as illustrated in (c) of FIG. 22, even when the size of the display region of the display 2510 is the same as the second size, the processor 830 may display a second type of screen interface 2200c, which is different from the first type of screen interface 2200b in (b) of FIG. 22, based on a preset type of manipulation (e.g., a swipe operation) applied to the rollable display.

Compared to the first type of screen interface, the screen interface 2200c of the second type may further include slope/curve information and navigation information (turn-by-turn information) on an optimal route.

As described above, according to the present disclosure, when the size of the display region of the rollable display is changed by a user manipulation, the rollable display may be controlled in various ways, and information displayed on the rollable display may be determined based on the changed display region.

Hereinafter, a method of controlling the unrolling or rolling of a rollable display provided in a vehicle by control of a route provision apparatus (or vehicle) without any user manipulation will be described in more detail with reference to the accompanying drawings.

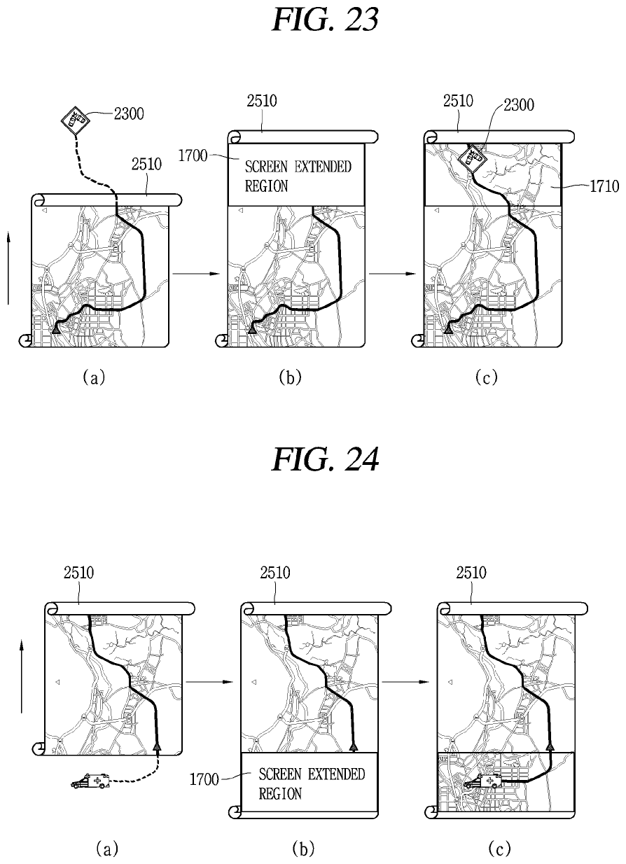

FIGS. 23, 24, 25, 26, and 27 are conceptual views for explaining an embodiment in which a rollable display is enlarged under the control of a route provision apparatus.

As illustrated in (a) of FIG. 23, while the rollable display displays map information in a display region having a first size, an event may occur at a point out of the map information displayed in the display region having the first size.

In this case, as illustrated in (b) of FIG. 23, the processor 830 may control the rollable display 2510 to enlarge the rollable display 2510 to a second size larger than the first size.

At this time, the processor 830 may determine the second size based on a point at which the event occurs.

That is, as the point at which the event occurs is farther from a current position of the vehicle, the processor 830 may control the rollable display 2510 to further stretch the rollable display (i.e., to further enlarge the display region of the rollable display).

The rollable display provided in the vehicle of the present disclosure may be configured to be automatically rolled or stretched by the route provision apparatus or the control of the vehicle, even without any user manipulation.

To this end, as an example, the rollable display may include a shaft around which the rollable display is rolled, an actuator that rotates the shaft, and a guide unit configured to fix an unrolled rollable display.

The processor 830 may transmit a control command for allowing the rollable display to be stretched or rolled to the rollable display. In this case, the rollable display may rotate the shaft by operating an actuator according to the control command. Accordingly, a display region of a display panel of the rollable display may be extended or reduced by the rotation of the shaft.

The display region of the rollable display described in this specification may refer to a stretched portion of the display panel of the rollable display.

Under the control of the processor 830 of the route provision apparatus, the display region of the rollable display 2510 may be extended as illustrated in (b) of FIG. 23.

The processor 830 may receive map information corresponding to the extended region from the server (or memory) to display the received map information, and display information 2300 corresponding to the event in the extended region.

On the other hand, when an event occurs at the rear of the vehicle among points out of the map information displayed on the rollable display 2510 (e.g., when a vehicle (e.g., ambulance, police car, fire engine, etc.) sounding a siren is detected) as illustrated in (a) of FIG. 24, the processor may control the rollable display 2510 to extend the rollable display 2510 as illustrated in (b) of FIG. 24.

In this case, since an event has occurred at the rear of the vehicle, the processor 830 may extend the rollable display in a downward direction, display map information corresponding to the rear of the vehicle in the extended region 1700 so as to display event information occurred in the rear of the vehicle in the extended region, and reflect and display the event information on map information corresponding to the rear of the vehicle as illustrated in (c) of FIG. 24.

For another example, even when an event occurs from the rear of the vehicle, the processor 830 may enlarge the rollable display in a preset direction (upper end), move the map information that has been previously displayed to be included in the extended region, and display map information and event information corresponding to the rear of the vehicle in a lower portion that becomes empty as a result of the movement.

In this manner, an event occurring in a zone (point) outside of map information may be determined (detected) by the processor 830 based on event information received from the server or event information received through road infrastructures, vehicles, mobile terminals, and the like, through V2X (vehicle to everything) communication.

Meanwhile, the processor 830 may determine a size of the display region of the rollable display 2510 based on a speed of the vehicle.

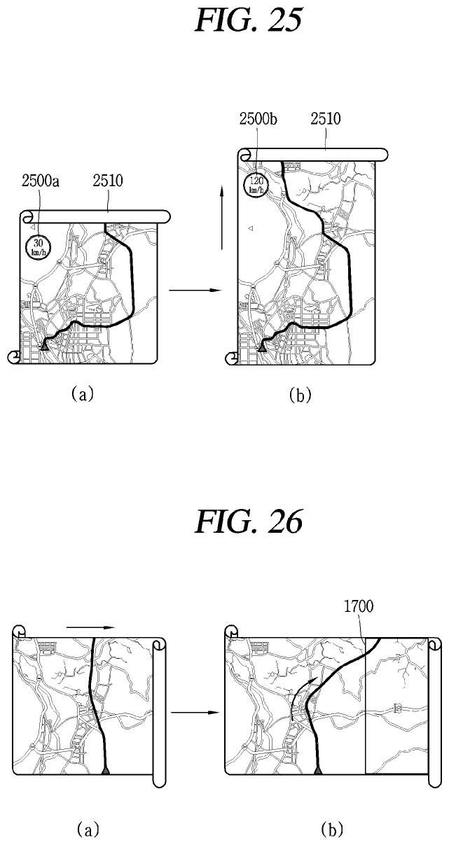

For example, as illustrated in (a) of FIG. 25, when the speed of the vehicle is a first speed (e.g., 30 km/h), the processor 830 may control the rollable display 2510 such that the size of the display region becomes the first size.

For another example, as illustrated in (b) of FIG. 25, when the speed of the vehicle is a second speed (e.g., 120 km/h) higher than the first speed, the processor 830 may control the rollable display 2510 such that the size of the display region becomes the second size greater than the first size.

That is, the processor 830 of the route provision apparatus of the present disclosure may enlarge the display region of the rollable display such that map information and an optimal route in a larger region are displayed as the speed of the vehicle increases.

Furthermore, the processor 830 may determine the size of the display region and vary the display region of the rollable display 2510 in proportion to the speed of the vehicle.

In this case, in the rollable display 2510, the display region may be automatically varied by the route provision apparatus or the vehicle depending on the speed of the vehicle (i.e., the display region may be varied without user intervention).

Meanwhile, the processor 830 may vary the display region of the rollable display 2510 based on a state in which the vehicle must drive.

For example, as illustrated in (a) of FIG. 26, while map information and an optimal route are displayed on the rollable display, the processor 830 may detect (determine) that a direction indicator lamp of the vehicle is turned on or a section with more than a predetermined curvature is present in front of a predetermined distance from a current location of the vehicle.

In this case, when the direction indicator lamp of the vehicle is turned on, the processor 830 may extend the rollable display 2510 in a direction (e.g., right) corresponding to a direction in which the turn indicator lamp of the vehicle is turned on so as to display map information to be extended in a direction in which turn indicator lamp is turned on, and display map information in the extended region.

For another example, when a section having a predetermined curvature or more is present in front of a predetermined distance from a current location of the vehicle, as illustrated in (b) of FIG. 26, the processor 830 may control the rollable display 2510 to extend the rollable display 2510 in a direction (e.g., right in the case of a road curved to the right) corresponding to a curved direction in which the section having a predetermined curvature or more is curved.

Meanwhile, the processor 830 may vary (determine) a size of the display region of the rollable display 2510 based on the driving type of the vehicle.

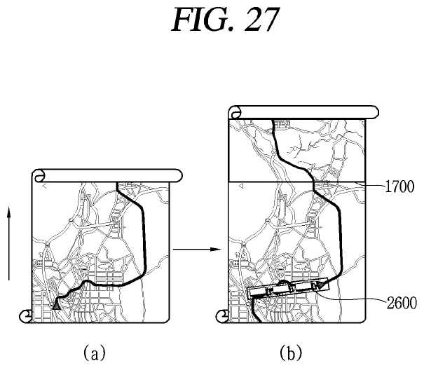

For example, as illustrated in (a) of FIG. 27, when the vehicle is driving alone (e.g., when the vehicle is driving alone regardless of manual driving or autonomous driving), the processor 830 may control the rollable display 2510 such that the size of the region becomes a first size.

For another example, as illustrated in (b) of FIG. 27, when the vehicle is performing platooning (when the vehicle is platooning regardless of whether it is a preceding vehicle or a following vehicle of the platooning), the processor 830 may control the rollable display 2510 to be enlarged to have a second size larger than the first size.

Then, the processor 830 may further display map information, and also reflect and display a lane-based optimal route in the extended region.

Furthermore, as illustrated in (b) of FIG. 27, the processor 830 may further display a graphic object (notification information) 2600 indicating that platooning is in progress on the rollable display 2510.

As described above, the present disclosure may provide a control method for a new rollable display capable of automatically extending the rollable display according to various environments occurring during driving as well as when the display region of the rollable display is varied by a user manipulation.

The effects of a route provision apparatus according to the present disclosure and a route provision method therefor will be described as follows.

First, the present disclosure may provide a route provision apparatus optimized for generating or updating field-of-view information for autonomous driving.

Second, the present disclosure may provide a route provision apparatus capable of providing optimized map information and route information by utilizing a rollable display provided in a vehicle.

Third, the present disclosure may provide a user interface capable of utilizing an extended region in an optimized manner when the rollable display is enlarged by a user.

Fourth, the present disclosure provides a rollable display and a route provision apparatus to which a new control method capable of providing additional information in an optimized manner by enlarging the rollable display is applied when the additional information related to driving of a vehicle needs to be provided.

Hereinafter, the structural characteristics of the rollable display of the present disclosure will be described in more detail.

In the present specification, the rollable display 2510 may be referred to as a vehicle display device 2510. Furthermore, the above-described rollable display 2510 may refer to a flexible display 2400 to be described later.

Hereinafter, a detailed structure of the rollable display 2510 (vehicle display device 2510) described above will be described.

The vehicle display device 2510 may be understood as an example of the above-described display module 251 of the vehicle.

The vehicle display device 2510 may include at least one antenna for wireless communication. The antenna may be built into the vehicle display device 2510 or may be disposed in a case. For example, the antenna constituting part of the broadcast reception module 111 (see FIG. 1) may be configured to be withdrawable from the vehicle display device 2510. Alternatively, the antenna may be formed in a film type and attached to an inner surface of the housing, or a case including a conductive material may function as the antenna.

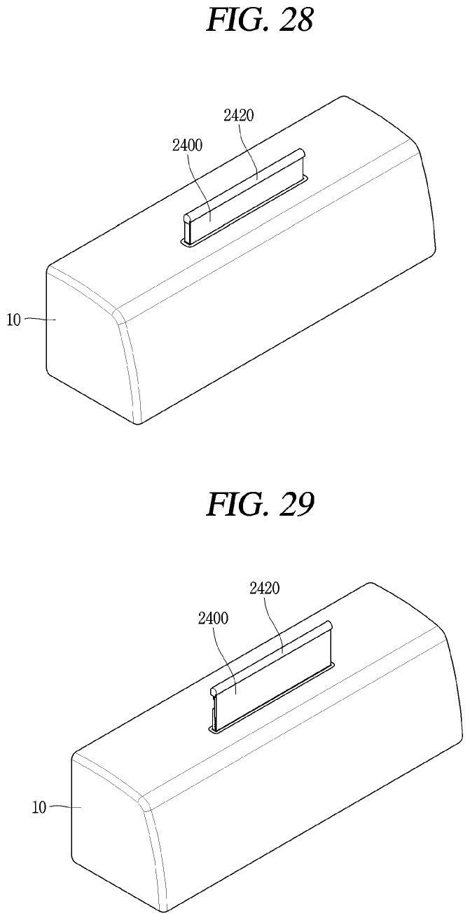

FIG. 28 is a perspective view showing the vehicle display device 2510 according to an embodiment. FIG. 29 is a perspective view showing the vehicle display device 2510 whose state is changed in FIG. 28.

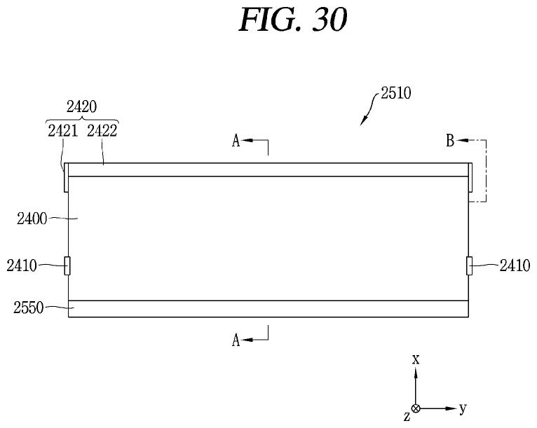

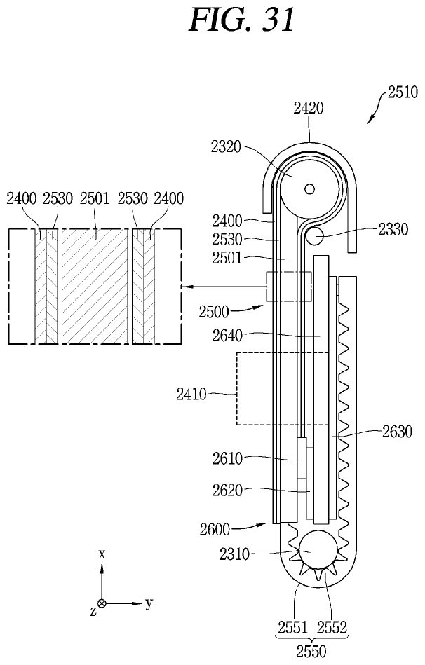

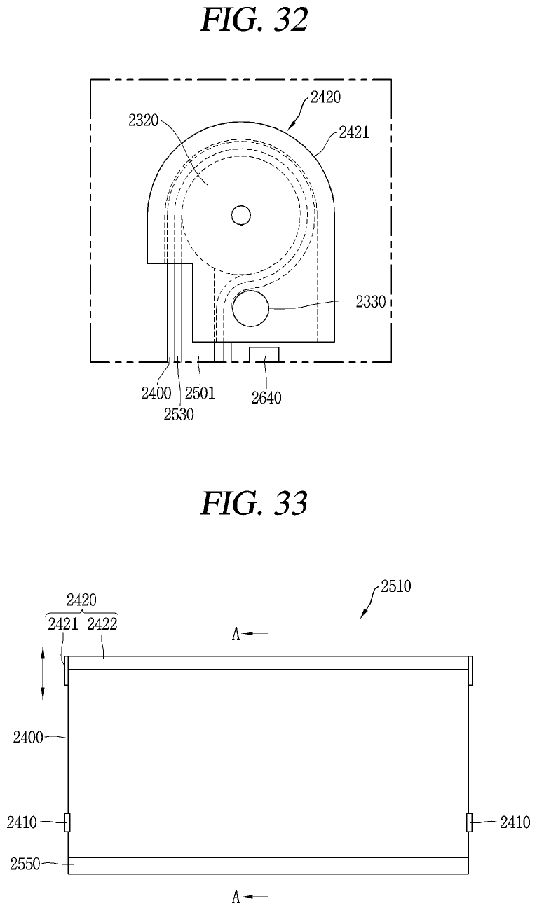

FIG. 30 is a front view showing the vehicle display device 2510 according to an embodiment. FIG. 31 is a cross-sectional view in which a portion A-A of FIG. 30 is viewed in a direction shown. FIG. 32 is a view in which a portion B-B of FIG. 30 is viewed in a direction shown.

The vehicle display device 2510 may include a first frame 2410, a second frame 2420, a first roller 2310, a second roller 2320, and a flexible display 2400.

The first frame 2410 may be provided to be fixed to a dashboard 10 of the vehicle. A groove accommodating the vehicle display device 2510 may be disposed in the dashboard 10 of the vehicle, and the first frame 2410 may be disposed at an appropriate position inside the groove.

In this case, the first frame 2410 may be fixedly coupled to the dashboard 10 by screwing, interference fit, or another appropriate coupling method.

The second frame 2420 may be provided to be movable in a first direction with respect to the first frame 2410. The second roller 2320 may be rotatably coupled to the second frame 2420 with a pin, and accordingly, as the second frame 2420 moves in the first direction, the second roller 2320 may also rotate in the first direction.

The first direction may be, for example, a vertical direction of the vehicle or a direction inclined to the vertical direction at a predetermined angle with the vertical direction. The first direction may be a direction substantially parallel to a front surface of the flexible display 2400. The first direction may be appropriately adjusted for the convenience of a driver viewing the flexible display 2400.

The first roller 2310 may be provided to be spaced apart from the first frame 2410. The first roller 2310 may be provided to be rotatably spaced apart from the first frame 2410 without being coupled to the first frame 2410.

In addition, the first roller 2310 may be provided in a bar shape with its length direction perpendicular to the first direction to support the flexible display 2400, a support bar 2550, or a chain 2520 in a direction perpendicular to the width direction, that is, the first direction, of the flexible display 2400, the support bar 2550, or the chain 2520.

The second roller 2320 may be rotatably coupled to the second frame 2420 to move in the first direction according to the movement of the second frame 2420.

In addition, the second roller 2320 may be provided in a bar shape with its length direction perpendicular to the first direction to support the flexible display 2400 in a direction perpendicular to the width direction, that is, the first direction, of the flexible display 2400.

As illustrated in FIGS. 30, 31 and 32, the second frame 2420 may include a pair of bodies 2421 and a connection bar 2422.

The pair of bodies 2421 are provide, and the second roller 2320 is coupled with a pin to support both sides of the second roller 2320. Accordingly, the second roller 2320 may be rotatably coupled to the body 2421 to move in the first direction as the second frame 2420 moves in the first direction.

The connection bar 2422 may connect the pair of bodies 2421 to each other. Here, for example, the pair of bodies 2421 and the connecting bar 2422 may be integrally manufactured. Furthermore, the connection bar 2422 may serve to allow the flexible display 2400 to be in close contact with the second roller 2320.

Referring to FIG. 32, the flexible display 2400 may be disposed in a space formed between an inner surface of the connection bar 2422 and a surface of the second roller 2320, and the flexible display 2400 may be guided by the inner surface of the connection bar 2422 to be in close contact with the surface of the second roller 2320.

A degree of allowing the flexible display 2400 to be in close contact with to the surface of the second roller 2320 may be adjusted by appropriately adjusting a distance of the space. One surface of the flexible display 2400 may be designed to be directly in contact with the surface of the second roller 2320. However, when a back plate 2530 is provided between the flexible display 2400 and the second roller 2320, the flexible display 2400 and the second roller 2320 may not be directly in contact with each other.

When the back plate 2530 is provided, a size between the inner surface of the connecting bar 2422 and the surface of the second roller 2320 may be appropriately selected in consideration of a thickness of the back plate 2530. The back plate 2530 will be specifically described below.

Meanwhile, referring to FIG. 32, the body 2421 may be fixedly coupled to a movable plate 2501. Since the movable plate 2501 moves in the first direction, therefore, as the movable plate 2501 moves, the second frame 2420 and the second roller 2320 coupled to the second frame 2420 may also move in the first direction.

A portion of the flexible display 2400 may be provided to be wound around the second roller 2320 and bent by the second roller 2320, and one end thereof may be fixed to the first frame 2410.

The flexible display 2400 may be formed of a flexible material and, therefore, may be wound around the second roller 2320. When rolled by the second roller 2320, the flexible display 2400 may be bent or curved by the second roller 2320.

In this case, the flexible display 2400 may be bent at a portion in close contact with the second roller 2320, and may maintain an even flat shape that is not bent at the remaining portion. However, a portion in close contact with the third roller 2330 described later may also be bent by the third roller 2330.

The flexible display 2400 refers to a light and non-fragile rigid display fabricated on a thin and flexible substrate capable of being curved, bent, folded, twisted or rolled like a paper sheet while maintaining the characteristics of a flat panel display.

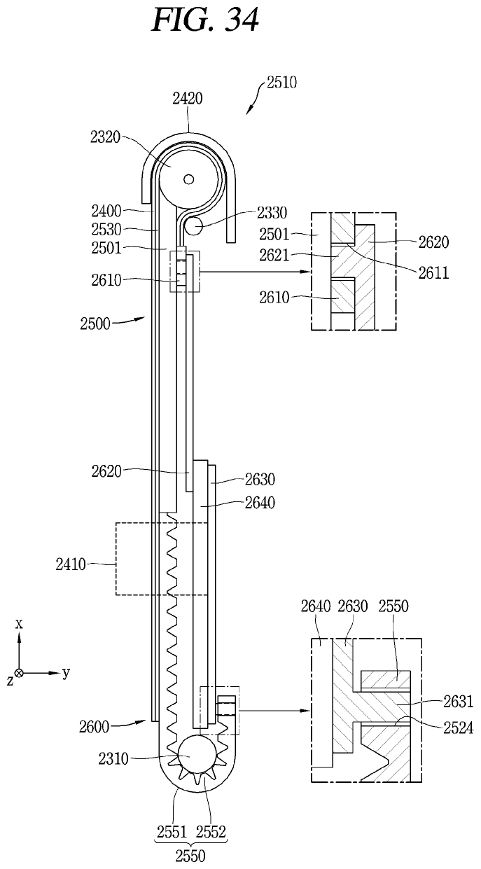

FIG. 33 is a front view showing the vehicle display device 2510 whose state is changed in FIG. 30. FIG. 34 is a cross-sectional view in which a portion A-A of FIG. 33 is viewed in a direction shown.

The flexible display 2400 may be provided to increase an externally exposed area of the front surface as a distance between the first roller 2310 and the second roller 2320 increases. In this case, the externally exposed area of the flexible display 2400 may be defined as an area of a portion of the flexible display 2400 that is exposed to an outside of the dashboard 10 and can be seen by the driver and passengers of the vehicle.

FIGS. 28, 30, and 31 illustrate a state in which the externally exposed area of the flexible display 2400 is relatively small. FIGS. 29, 33, and 34 illustrate a state in which the externally exposed area of the flexible display 2400 is relatively large.

The second roller 2320 in the state of FIG. 31 may move in the first direction, and a distance between the first roller 2310 and the second roller 2320 may increase to become the state of FIG. 34. At this time, since one end portion of the flexible display 2400 is fixed to the first frame 2410 that does not move in the first direction, a portion of the flexible display 2400 fixed to the first frame 2410 does not move in the first direction.

As the second roller 2320 moves in the first direction to allow the second roller 2320 to rise relative to the first roller 2310, part of a portion of the flexible display 2400 that is not fixed to the first frame 2410 may pass through a section that is bent by the second roller 2320 so as to be flatly unfolded.

Due to such a structure, when a distance between the first roller 2310 and the second roller 2320 increases as the second roller 2320 moves in the first direction, the externally exposed area of the flexible display 2400 may increase.

In other words, the flexible display 2400 may switch from a first state to a second state when the second roller 2320 moves in the first direction to be away from the first roller 2310, and may switch from the second state to the first state when the second roller 2320 moves in the first direction to be closer to the first roller 2310.

For example, FIGS. 28, 30 and 31 illustrate the flexible display 2400 in the first state, and FIGS. 29, 33 and 34 illustrate the flexible display 2400 in the second state.

Referring to the drawings, the flexible display 2400 may have a larger externally exposed area on its front surface in the second state than in the first state.

Accordingly, due to foregoing the structure, the externally exposed area of the flexible display 2400 may decrease when a distance between the first roller 2310 and the second roller 2320 decreases in the first direction, the externally exposed area of the flexible display 2400 may increase when the distance between the and the second roller 2320 increases in the first direction.

The vehicle display device 2510 may further include a movement unit 2500 and a guide unit 2600. The movement unit 2500 may serve to move the second roller 2320 in the first direction. The guide unit 2600 may serve to guide the movement of the movement unit 2500.

The movement unit 2500 may include a movable plate 2501 and a support bar 2550. However, in another embodiment, a chain 2520 may be used in place of the support bar 2550. The support bar 2550 will be described first, and the chain 2520 will be described later using separate drawings.

The movable plate 2501 may be made of a rigid material, and one end portion thereof may be fixedly coupled to the second frame 2420. The movable plate 2501 may be provided to move in the first direction as the second roller 2320 moves in the first direction.

Meanwhile, since the second roller 2320 moves in the first direction together with the second frame 2420, the movable plate 2501 may move in the first direction together with the second frame 2420 as it moves in the first direction.

A flat surface of the flexible display 2400 may be in close contact with one surface of the movable plate 2501, and thus the flexible display 2400 may maintain a flat surface by the movable plate 2501.

One end portion of the support bar 2550 may be coupled to the movable plate 2501. The support bar 2550 and the movable plate 2501 may be coupled to each other by, for example, an adhesive. When unfolded, the support bar 2550 may have a plate shape as a whole, but may be bent by the first roller 2310.

As the movable plate 2501 moves in the first direction, the support bar 2550 may move while a portion of the support bar 2550 is wound around the first roller 2310. As illustrated in FIGS. 31 and 34, as the second roller 2320 moves away from the first roller 2310, the support bar 2550 may move in a direction closer to the first roller 2310 in the first direction, and move in a direction away from the first roller 2310 in the first direction as an advancing direction thereof is changed by 180° due to being bent by the first roller 2310.

Furthermore, a support bar 2550 may be provided to support at least part of a rear surface of the flexible display 2400. Referring to FIG. 34, when the second roller 2320 moves away from the first roller 2310 in the first direction, part of the support bar 2550, that is, part adjacent to a portion coupled to the movable plate 2501 may be bent by the first roller 2310 to change its direction so as to move in the same direction as the second roller 2320, thereby supporting part of the rear surface of the flexible display 2400.

Due to such a structure, part of the flexible display 2400, for example, a flat portion thereof, may be provided to be in close contact with the movable plate 2501 or the support bar 2550.

Similarly, when the chain 2520 is provided instead of the support bar 2550, part of the flexible display 2400 may be provided so as to be in close contact with the movable plate 2501 or the chain 2520.

The support bar 2550 may be formed of a flexible material to be bendable, and may include a base 2551 and a support portion 2552. The base 2551 and the support portion 2552 may be integrally manufactured, or in another embodiment, the support portion 2552 may be bonded to the base 2551 to constitute the support bar 2550. In this case, the base 2551 and the support portion 2552 may be formed of the same material.

The support bars 2550 may be connected to each other at the base 2551. The support portion 2552 may have a trapezoidal cross section and, referring to FIG. 31, may be provided in a bar shape in a direction perpendicular to the first direction.

A plurality of support portions 2552 may be provided, and respective the support units 2552 may be arranged at regular intervals in a movement direction of the support bar 2550. When the support portion 2552 is wound and bent around the first roller 2310, a cross section of the support portion 2552 may be appropriately defined in a trapezoidal shape to prevent interference between support portions 2552 adjacent to each other due to bending.

The vehicle display device 2510 may further include a third roller 2330. The third roller 2330 may be rotatably coupled to the second frame 2420 to support the flexible display 2400 such that part of the flexible display 2400 is in close contact with the movable plate 2501.

In addition, the third roller 2330 may be provided in a bar shape with its length direction perpendicular to the first direction to support the flexible display 2400 in a direction perpendicular to the width direction, that is, the first direction, of the flexible display 2400.

As illustrated in FIGS. 31 and 34, the second roller 2320 and the third roller 2330 may be spaced apart from each other to form a space therebetween. The space may be disposed to allow the flexible display 2400 to pass therethrough.

Due to such a structure, the flexible display 2400 may be supported by the second roller 2320 and the third roller 2330, and the flexible display 2400 may more effectively be in close contact with the movable plate 2501.

The flexible display 2400 may be easily bent or curved, and according to an embodiment, the flexible display 2400 may be allowed to be in close contact with the movable plate 2501 using the second roller 2320 and the third roller 2330, thereby securing a plane that is not bent or curved on a portion of the flexible display 2400 at a portion corresponding to the movable plate 2501. Accordingly, the flexible display 2400 may provide an image of improved quality to a driver or the like.

The third roller 2330 may be rotatably coupled to the body 2421 of the second frame 2420 together with the second roller 2320. Accordingly, the third roller 2330 may move in the first direction together with the second roller 2320 as the second roller 2320 moves in the first direction. In this case, a spacing distance between the second roller 2320 and the third roller 2330 may be maintained constant regardless of movement in the first direction.

Due to such a structure, even when the externally exposed area of the flexible display 2400 increases or decreases as the second roller 2320 moves in the first direction, regardless of this, the second roller 2320 and the third roller 2330 may effectively allow the flexible display 2400 to be in close contact with the movable plate 2501.

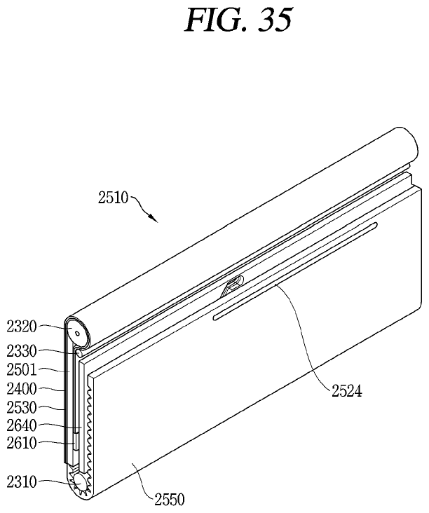

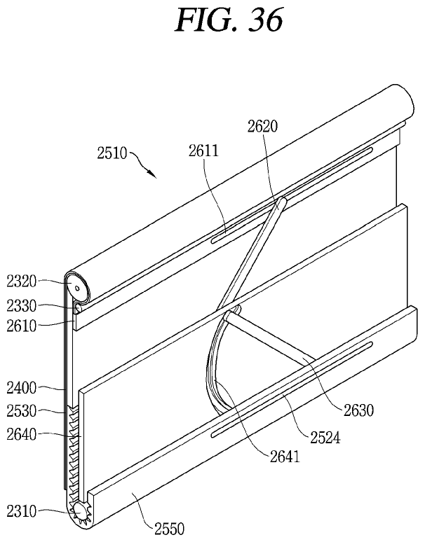

FIG. 35 is a perspective view showing some elements of the vehicle display device 2510 according to an embodiment. FIG. 36 is a perspective view showing the vehicle display device 2510 whose state is changed in FIG. 35. FIGS. 35 and 36 illustrate a state in which some of the elements of the vehicle display device 2510 are deleted for clarity.

Referring to FIGS. 35 and 36, the guide unit 2600 may include a connection body 2610, a first control bar 2620, a second control bar 2630 and an inner plate 2640.

The connection body 2610 may be coupled to one end of the flexible display 2400. The flexible display 2400 may be coupled to the connection body 2610 by, for example, an adhesive. The connection body 2610 may move in the first direction according to the rotation of the first control bar 2620.

As illustrated in FIGS. 35 and 36, a length direction of the connection body 2610 may be disposed in a direction perpendicular to the first direction to guide the flexible display 2400 to move in the first direction while having the same location in a width direction thereof, that is, in a direction perpendicular to the first direction.

The externally exposed area of the flexible display 2400 may decrease when the connection body 2610 is closer to the first roller 2310, and the externally exposed area of the flexible display 2400 may increase when the connection body 2610 is away from the first roller 2310.

One end of the first control bar 2620 may be provided to be coupled to the connection body 2610 and to be movable in a direction perpendicular to the first direction with respect to the connection body 2610. Furthermore, the first control bar 2620 may be provided to rotate as the second roller 2320 moves in the first direction.

When the second roller 2320 moves in the first direction to move away from or closer to the first roller 2310, the first control bar 2620 may rotate clockwise or counterclockwise to pull the connection body 2610.

The first control bar 2620 may pull the connection body 2610 regardless of the location of the second roller 2320 in the first direction, thereby increasing a degree of close contact between the flexible display 2400 and the movable plate 2501, the second roller 2320 or the third roller 2330.

One end of the second control bar 2630 may be provided to be coupled to the other end of the first control bar 2620 so as rotate as the second roller 2320 moves in the first direction. The first control bar 2620 and the second control bar 2630 may be rotatably coupled to each other.

The other end of the second control bar 2630 may be coupled to the support bar 2550 or an end portion of the chain 2520, and when the second roller 2320 moves away from or closer to the first roller 2310 in the first direction, the second control bar 2630 may rotate clockwise or counterclockwise to pull the support bar 2550 or the chain 2520.

The second control bar 2630 may pull the support bar 2550 or the chain 2520 regardless of the location of the second roller 2320 in the first direction, thereby increasing a degree of close contact between the support bar 2550 or the chain 2520 and the first roller 2310.

In order to allow the first control bar 2620 to pull the connection body 2610 and allow the second control bar 2630 to pull the support bar 2550 or chain 2520, the first control bar 2620 and the second control bar 2630 need to have a restoring force with respect to rotation in a direction of decreasing an angle between the first control bar 2620 and the second control bar 2630.

Therefore, for this purpose, a second elastic portion 2720 may be disposed at a coupling portion between the first control bar 2620 and the second control bar 2630. The second elastic portion 2720 will be described in detail with reference to the drawings below.

The inner plate 2640 may be provided to be fixed to the first frame 2410 so as to allow the coupling portion between the first control bar 2620 and the second control bar 2630 to pass therethrough. The inner plate 2640 may include a second slot 2641 to be described later, and the inner plate 2640 may guide the movement of the coupling portion between the first control bar 2620 and the second control bar 2630 using the second slot 2641.

In order to guide the rotation and movement of the first frame 2410 and the second frame 2420, a first slot 2611, a second slot 2641, and a third slot 2524 may be provided.

The connection body 2610 may include the first slot 2611 into which a first protrusion 2621 protruding from one end of the first control bar 2620 is inserted, and a length direction of which is defined in a direction perpendicular to the first direction so as to guide the movement of the connection body 2610 with respect to the first control bar 2620.

Accordingly, one end of the first control bar 2620 may be coupled to the first slot 2611 to be movable in a direction perpendicular to the first direction, and may be guided and moved by the first slot 2611.

The inner plate 2640 may include the second slot 2641 into which a coupling portion between the first control bar 2620 and the second control bar 2630 is inserted to guide the movement of the coupling portion.

The coupling portion between the first control bar 2620 and the second control bar 2630 may be coupled to allow the first control bar 2620 and the second control bar 2630 to rotate with each other, and the coupling portion may be guided by the second slot 2641 disposed to pass through the inner plate 2640 to move on the inner plate 2640.

The second slot 2641 may be disposed to have an appropriate curvature in consideration of a designed movement of the first control bar 2620 and the second control bar 2630.

The support bar 2550 or the chain 2520 may include the third slot 2524 into which a second protrusion 2631 protruding from one end of the second control bar 2630 is inserted, and a length direction of which is defined in a direction perpendicular to the first direction so as to guide the movement of the second control bar 2520 with respect to the chain 2520.

Accordingly, one end of the second control bar 2630 may be coupled to the third slot 2524 so as to be movable in a direction perpendicular to the first direction, and may be guided and moved by the third slot 2524.

Meanwhile, the movement unit 2500 may further include a back plate 2530. The back plate 2530 may be disposed to face the flexible display 2400, and at least a portion of the back plate 2530 may be formed of a metal plate having elasticity.

The flexible display 2400 may be easily bent or curved, and according to an embodiment, the back plate 2530 in close contact with the flexible display 2400 may be provided on a rear surface of the flexible display 2400, thereby securing a plane of the flexible display 2400 that is not bent or curved the back plate 2530 due to the back plate 2530 supporting the flexible display 2400. Accordingly, the flexible display 2400 may provide an image of improved quality to a driver or the like.

Referring to FIGS. 31 and 34, the back plate 2530 having a size and shape corresponding to that of the flexible display 2400 may be coupled to the flexible display 2400 to move integrally with the flexible display 2400.

The foregoing present disclosure may be implemented as codes (an application or software) readable by a computer on a medium written by the program. The control method of the above-described autonomous vehicle may be implemented by codes stored in a memory or the like.

The computer-readable media may include all kinds of recording apparatuses in which data readable by a computer system is stored. Examples of the computer-readable media may include a hard disk drive (HDD), a solid-state disk (SSD), a silicon disk drive (SDD), a ROM, a RAM, a CD-ROM, a magnetic tape, a floppy disk, an optical data storage device, and the like, and also include a device implemented in the form of a carrier wave (e.g., transmission via the Internet). In addition, the computer may include a processor or controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

1. A route provision apparatus that provides a route to a vehicle, the route provision apparatus comprising:
a telecommunication control circuit that receives map information from a server, the map information configured with a plurality of layers;
an interface circuit that receives sensing information from one or more sensors provided in the vehicle, the one or more sensors including an image sensor; and
a processor that:
specifies a lane in which the vehicle is located on a road consisting of a plurality of lanes based on an image received from the image sensor,
using the map information, estimates a lane-based optimal route to move the vehicle to the specified lane, the lane-based optimal route being an optimal route specified in units of lanes,
generates autonomous driving field-of-view information on the lane-based optimal route, the autonomous driving field-of-view information being merged with the sensing information and transmitted to at least one of the server or an electrical part provided in the vehicle,
merges dynamic information for guiding a movable object located on the lane-based optimal route into the autonomous driving field-of-view information, and
updates the lane-based optimal route based on the dynamic information, wherein the processor:
displays the map information received from the server on a rollable display provided in the vehicle,
determines that a size of a display region of the rollable display is subsequently changed, and
requests and receives updated map information to be displayed in the changed display region from the server based on the changed size of the display region.

2. The route provision apparatus of claim 1,
wherein the changed size of the display region of the rollable display comprises an enlargement of the display region of the rollable display that includes an extended region of the display region, and
wherein the processor determines a size of the extended region of the display region when the size of the display region of the rollable display is enlarged.

3. The route provision apparatus of claim 2, wherein the map information is tile-based map information, and wherein the processor requests and receives the tile-based map information corresponding to the size of the extended region from the server, and displays the received tile-based map information in the extended region.

4. The route provision apparatus of claim 3, wherein the processor generates the lane-based optimal route corresponding to the received tile-based map information.

5. The route provision apparatus of claim 4, wherein the processor controls the rollable display to reflect and display the generated lane-based optimal route on the tile-based map information displayed in the extended region.

6. The route provision apparatus of claim 1, wherein the map information is tile-based map information, and wherein based on the tile-based map information to be displayed in the changed display region being previously stored in a memory, the processor:
extracts the stored tile-based map information to be displayed in the changed display region from the memory instead of requesting map information from the server, and
displays the extracted tile-based map information in the changed display region of the rollable display.

7. The route provision apparatus of claim 1, wherein the map information is tile-based map information, and based on the changed size of the display region of the rollable display being an enlargement of the display region of the rollable display that includes an extended region of the display region, the processor:
receives from the server the updated map information corresponding to the size of the extended region to display the received map information,
generates a new lane-based optimal route from the map information displayed in the extended region, and
displays the new lane-based optimal route on the map information displayed in the extended region.

8. The route provision apparatus of claim 1, wherein the map information is tile-based map information, and based on the changed size of the display region of the rollable display being an enlargement of the display region of the rollable display that includes an extended region of the display region, the processor:
receives first map information from the server in units of a first number of tiles,
displays the received first map information on the rollable display before the size of the display region of the rollable display is enlarged,
receives second map information from the server in units of a second number of tiles greater than the first number of tiles, and
displays the second received map information on the rollable display so as to display the map information in the extended region when the display region of the rollable display is enlarged.

9. The route provision apparatus of claim 8, wherein the processor displays a graphic object that divides the tile-based map information on the rollable display so as to identify the tile-based map information.

10. The route provision apparatus of claim 1, wherein based on the display region of the rollable display being enlarged, the processor:
receives from the server a specific number of layers among the plurality of layers constituting the map information displayable in the extended region, and
displays the received specific number of layers in the extended region.

11. The route provision apparatus of claim 10, wherein based on the vehicle entering within a predetermined distance from a place corresponding to a predetermined point of map information displayed in the extended region, the processor receives from the server any remaining layers among the plurality of layers constituting the map information displayable in the extended region.

12. The route provision apparatus of claim 2, wherein based on new map information is-being displayed in the extended region as the display region of the rollable display is enlarged, the processor extends a sensing range of the one or more sensors in a direction corresponding to a direction in which the new map information is displayed.

13. The route provision apparatus of claim 1, wherein the processor displays at least one of the map information or the lane-based optimal route on the rollable display in a different manner based on the size of a display region of the rollable display.

14. The route provision apparatus of claim 1, wherein the changed size of the display region of the rollable display comprises an enlargement of the display region of the rollable display that is initiated by the processor based on an event occurring at a point within the map information displayed in the display region.

15. The route provision apparatus of claim 14, wherein the processor determines a size of the enlargement based on the point at which the event occurs.
